(19) United States
(12) Patent Application Publication
(10) Pub. No.: US 2026/0250453 A1
(43) Pub. Date: Aug. 27, 2026

(54) ORGANOPOLYSILOXANE COMPOUND AND POLYMER THEREOF

(71) Applicant: JNC CORPORATION, Tokyo (JP)

(72) Inventor: Takaya OHNO, Chiba (JP)

(73) Assignee: JNC CORPORATION, Tokyo (JP)

(21) Appl. No.: 19/539,066

(22) Filed: Feb. 13, 2026

(30) Foreign Application Priority Data
Feb. 26, 2025 (JP) 2025-029281

(51) Int. Cl. C08F 283/12; C08G 77/20; C08J 5/18

(52) U.S. Cl. CPC C08F 283/124; C08G 77/20; C08J 5/18; C08J 2351/08

(57) ABSTRACT

Provided is a polysiloxane compound having a cycloolefin skeleton only at one terminal of a polysiloxane chain that can be composited with cycloolefin without forming a crosslinked system. An organopolysiloxane compound is represented by formula (1).

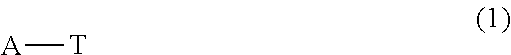

A is a monovalent alicyclic hydrocarbon group having 4 to 60 carbon atoms and having at least one carbon-carbon double bond, and T is a group represented by formula (2).

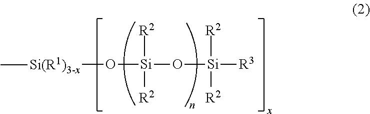

R¹ and R² are independently alkyl having 1 to 10 carbon atoms or aryl having 6 to 10 carbon atoms, R³ is alkyl having 4 to 10 carbon atoms, x is an integer of 1 to 3, and n is an integer of 1 or more.

### CROSS-REFERENCE TO RELATED APPLICATION

This application claims the priority benefit of Japanese Application Serial No. 2025-029281, filed on Feb. 26, 2025. The entirety of the above-mentioned patent application is hereby incorporated by reference herein and made a part of this specification.

### TECHNICAL FIELD

The disclosure relates to an organopolysiloxane compound having a cycloolefin skeleton that can be composited with a cycloolefin monomer, and further relates to a polymer formed by reacting the organopolysiloxane compound with a raw material including a cycloolefin monomer.

### BACKGROUND ART

An organopolysiloxane compound is a compound having a main chain skeleton composed of siloxane bonds (—Si—O—Si—) and having organic substituents at terminals and side chains, and exhibits excellent properties derived from the siloxane bonds, such as heat resistance, weather resistance, electrical properties, water repellency, and mold releasability. Since the above-mentioned characteristics of the organopolysiloxane compound can be imparted by compositing the organopolysiloxane compound with general-purpose organic polymers, the organopolysiloxane compound is used for modification of organic polymers.

Generally, a method for compositing an organopolysiloxane compound with an organic polymer involves incorporating an organopolysiloxane compound having a reactive functional group into the polymerization system of an organic polymer and copolymerizing.

Patent Document 1 (Japanese Patent Application Laid-Open No. 2008-274278) discloses a polysiloxane compound with a branched structure having a methacryl group as a reactive functional group. Further, Patent Document 2 (Japanese Patent Application Laid-Open No. 2003-212973) discloses an organopolysiloxane compound having multiple cycloolefin skeletons at both terminals of a polysiloxane chain and at side chains of the polysiloxane chain.

However, no studies have been conducted on an organopolysiloxane compound having a cycloolefin skeleton only at one terminal of a polysiloxane chain.

The disclosure provides an organopolysiloxane compound having a cycloolefin skeleton only at one terminal of a polysiloxane chain that can be composited with cycloolefin without forming a crosslinked system.

The inventors of the disclosure conducted intensive studies in order to solve the above problem. As a result, they found that it is possible to synthesize an organopolysiloxane compound having a cycloolefin skeleton only at one terminal of a polysiloxane chain by reacting a polysiloxane obtained by reaction of an organometallic compound and a cyclic siloxane with a chlorosilane compound having a cycloolefin skeleton. They also found that it is possible to modify the surface of a cycloolefin polymer by adding the obtained cycloolefin-containing organopolysiloxane to a polymerization system of a cycloolefin monomer and performing polymerization.

### SUMMARY

According to the disclosure, the organopolysiloxane compound shown below is provided.

Item 1. An organopolysiloxane compound represented by formula (1).

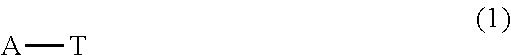

In formula (1), A is a monovalent alicyclic hydrocarbon group having 4 to 60 carbon atoms and having at least one carbon-carbon double bond, and T is a group represented by formula (2).

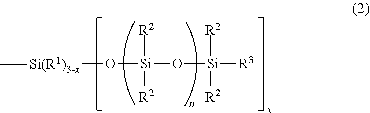

In formula (2), R¹ and R² are independently alkyl having 1 to 10 carbon atoms or aryl having 6 to 10 carbon atoms, R³ is alkyl having 4 to 10 carbon atoms, x is an integer of 1 to 3, n is an integer of 1 or more, in the case where there are multiple R¹ or R³ in the formula, the multiple R¹ or R³ may be the same or different, and multiple R² may be the same or different.

Item 2. The organopolysiloxane compound according to item 1, wherein A in formula (1) is a group represented by formula (3).

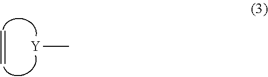

In formula (3), Y is a trivalent group composed of a hydrocarbon group having 2 to 36 carbon atoms, a substituted hydrocarbon group having 3 to 58 carbon atoms, a heteroatom-containing hydrocarbon group having 2 to 36 carbon atoms, or a substituted heteroatom-containing hydrocarbon group having 2 to 58 carbon atoms, and these trivalent groups may have at least one cyclic structure, and these trivalent groups may have an unsaturated bond.

Item 3. The organopolysiloxane compound according to item 1 or item 2, wherein A in formula (1) is a group represented by formula (4a), formula (4b), formula (4c), or formula (4d).

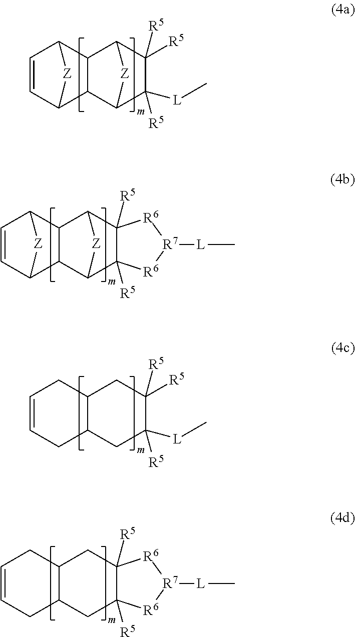

In formula (4a) to formula (4d), R⁵ is independently hydrogen or a monovalent hydrocarbon group having 1 to 4 carbon atoms, which may have an unsaturated bond, R⁶ is independently a divalent group composed of a hydrocarbon group having 1 to 4 carbon atoms, a substituted hydrocarbon group having 3 to 20 carbon atoms, a heteroatom-containing hydrocarbon group having 1 to 4 carbon atoms, or a substituted heteroatom-containing hydrocarbon group having 1 to 20 carbon atoms, and these divalent groups may have an unsaturated bond, R⁷ is methine (CH) or a trivalent hetero element, L is a divalent hydrocarbon group having 2 to 10 carbon atoms, which may have an unsaturated bond, Z is methylene or 1,2-ethanediyl, and m is an integer of 0 to 3.

Item 4. The organopolysiloxane compound according to item 3, wherein A in formula (1) according to item 1 is a group represented by formula (4a), formula (4b), formula (4c), or formula (4d), R⁵ in formula (4a) or formula (4c) is hydrogen, L is 1,2-ethanediyl, m is 0, R⁵ in formula (4b) or formula (4d) is hydrogen, R⁶ is carbonyl, R⁷ is nitrogen, and L is 1,3-propanediyl.

Item 5. The organopolysiloxane compound according to item 4, wherein A in formula (1) according to item 1 is a group represented by formula (4a) or formula (4b), and x in formula (2) according to item 1 is 2 or 3.

Item 6. A polymer, obtained by polymerizing the organopolysiloxane compound according to any one of items 1 to 5 with a cycloolefin monomer.

Item 7. The polymer according to item 6, obtained by polymerizing in the presence of a metathesis polymerization catalyst.

Item 8. A free-standing film, including the polymer according to item 6 or item 7.

Item 9. A molded article, including the polymer according to item 6 or item 7.

According to the disclosure, an organopolysiloxane compound having a cycloolefin skeleton only at one terminal of a polysiloxane chain and being useful for surface modification of a cycloolefin polymer can be obtained.

### DESCRIPTION OF THE EMBODIMENTS

Hereinafter, embodiments of the disclosure will be described, but the disclosure is not limited to the following embodiments.

The terms used in this specification have the following meanings.

In this specification, “alkyl” means a saturated, straight-chain, branched-chain, or cyclic hydrocarbon having a specific number of carbon atoms.

In this specification, “halogen” or “halo” means chloro, fluoro, bromo, or iodo.

In this specification, “heteroatom” or “hetero element” means nitrogen, oxygen, phosphorus, or sulfur.

An organopolysiloxane compound of the disclosure is characterized by being represented by formula (1).

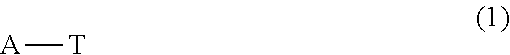

In formula (1), A is a monovalent alicyclic hydrocarbon group having 4 to 60 carbon atoms and having at least one carbon-carbon double bond, and T is a group represented by formula (2).

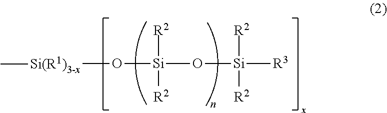

In formula (2), R¹ and R² are independently alkyl having 1 to 10 carbon atoms or aryl having 6 to 10 carbon atoms, R³ is alkyl having 4 to 10 carbon atoms, x is an integer of 1 to 3, n is an integer of 1 or more, in the case where there are multiple R¹ or R³ in the formula, the multiple R¹ or R³ may be the same or different, and multiple R² may be the same or different.

The monovalent alicyclic hydrocarbon group having 4 to 60 carbon atoms and having a carbon-carbon double bond in A of formula (1) is, for example, cyclobutenyl, cyclopentenyl, cyclopentadienyl, cyclohexenyl, cyclohexadienyl, cycloheptenyl, cyclooctenyl, cyclononenyl, cyclodecenyl, cyclododecenyl, cyclotetradecenyl, cyclohexadecenyl, cyclooctadecenyl, cycloeicoenyl, cyclodocoenyl, cyclotetracoenyl, cyclohexacoenyl, cyclooctacoenyl, norbornenyl, norbornadienyl, dicyclopentenyl, dicyclopentadienyl, dicyclohexenyl, dicyclohexadienyl, tricyclodecenyl, tetracyclododecenyl, tetracyclododecadienyl, and the like, and at least one hydrogen of these groups may be substituted with alkyl, halogen, heteroatom, haloalkyl, or heteroatom-substituted alkyl. The monovalent alicyclic hydrocarbon group having a carbon-carbon double bond has preferably 4 to 30 carbon atoms, and more preferably 5 to 15 carbon atoms.

The alkyl having 1 to 10 carbon atoms in R¹ and R² of formula (2) is, for example, methyl, ethyl, propyl, butyl, pentyl, hexyl, heptyl, octyl, nonyl, decyl, isopropyl, isobutyl, sec-butyl, tert-butyl, isopentyl, neopentyl, isohexyl, tert-hexyl, 2-methylpentyl, 3,3-dimethylbutyl, isoheptyl, 3-methylhexyl, 2,2,-dimethylpentyl, 3,3-dimethylpentyl, 2,3-dimethylpentyl, 2-ethylpentyl, 3-ethylpentyl, tert-heptyl, isooctyl, 2-methylheptyl, 3-methylheptyl, 4-methylheptyl, 2,2-dimethylhexyl, 3,3-dimethylhexyl, 2,3-dimethylhexyl, 2-ethylhexyl, 3-ethylhexyl, isononyl, 2-methyloctyl, 3-methyloctyl, 4-methyloctyl, 2,2-dimethylheptyl, 3,3-dimethylheptyl, 4,4-dimethylheptyl, 2,3-dimethylheptyl, 2,4-dimethylheptyl, 2,5-dimethylheptyl, 2,6-dimethylheptyl, 3,4-dimethylheptyl, 3,5-dimethylheptyl, 2-ethylheptyl, 3-ethylheptyl, 4-ethylheptyl, neononyl, isodecyl, 2-methylnonyl, 3-methylnonyl, 4-methylnonyl, 5-methylnonyl, 2,2-dimethyloctyl, 3,3-dimethyloctyl, 4,4-dimethyloctyl, 2,3-dimethyloctyl, 2,4-dimethyloctyl, 2,5-dimethyloctyl, 2,6-dimethyloctyl, 3,4-dimethyloctyl, 3,5-dimethyloctyl, 3,6-dimethyloctyl, 4,5-dimethyloctyl, 2-ethyloctyl, 3-ethyloctyl, 4-ethyloctyl, 3-propylheptyl, cyclobutyl, cyclopentyl, cyclohexyl, cycloheptyl, methylcyclohexyl, cyclooctyl, methylcycloheptyl, cyclononyl, methylcyclooctyl, cyclodecyl, methylcyclononyl, and the like, and the alkyl has preferably 1 to 4 carbon atoms.

The aryl having 6 to 10 carbon atoms is, for example, phenyl, benzyl, 2-toluyl, 3-toluyl, 4-toluyl, ethylphenyl, 2,3-xylyl, 2,4-xylyl, 2,5-xylyl, 2,6-xylyl, 3,4-xylyl, 3,5-xylyl, propylphenyl, isopropylphenyl, 1,2,3-trimethylphenyl, 1,2,4-trimethylphenyl, 1,3,5-trimethylphenyl, butylphenyl, isobutylphenyl, tert-butylphenyl, 1,2,3,4-tetramethylphenyl, 1,2,3,5-tetramethylphenyl, 1,2,4,5-tetramethylphenyl, 1-naphthyl, 2-naphthyl, and the like.

The alkyl having 4 to 10 carbon atoms in R³ of formula (2) is, for example, butyl, pentyl, hexyl, heptyl, octyl, nonyl, decyl, isobutyl, sec-butyl, tert-butyl, isopentyl, neopentyl, isohexyl, tert-hexyl, 2-methylpentyl, 3,3-dimethylbutyl, isoheptyl, 3-methylhexyl, 2,2-dimethylpentyl, 3,3-dimethylpentyl, 2,3-dimethylpentyl, 2-ethylpentyl, 3-ethylpentyl, tert-heptyl, isooctyl, 2-methylheptyl, 3-methylheptyl, 4-methylheptyl, 2,2-dimethylhexyl, 3,3-dimethylhexyl, 2,3-dimethylhexyl, 2-ethylhexyl, 3-ethylhexyl, isononyl, 2-methyloctyl, 3-methyloctyl, 4-methyloctyl, 2,2-dimethylheptyl, 3,3-dimethylheptyl, 4,4-dimethylheptyl, 2,3-dimethylheptyl, 2,4-dimethylheptyl, 2,5-dimethylheptyl, 2,6-dimethylheptyl, 3,4-dimethylheptyl, 3,5-dimethylheptyl, 2-ethylheptyl, 3-ethylheptyl, 4-ethylheptyl, neononyl, isodecyl, 2-methylnonyl, 3-methylnonyl, 4-methylnonyl, 5-methylnonyl, 2,2-dimethyloctyl, 3,3-dimethyloctyl, 4,4-dimethyloctyl, 2,3-dimethyloctyl, 2,4-dimethyloctyl, 2,5-dimethyloctyl, 2,6-dimethyloctyl, 3,4-dimethyloctyl, 3,5-dimethyloctyl, 3,6-dimethyloctyl, 4,5-dimethyloctyl, 2-ethyloctyl, 3-ethyloctyl, 4-ethyloctyl, and 3-propylheptyl, and the alkyl has preferably 4 carbon atoms.

n in formula (2) is preferably 10 to 150, and more preferably 15 to 80.

In formula (1), the monovalent alicyclic hydrocarbon group of A is preferably a group represented by formula (3).

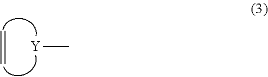

In formula (3), Y is a trivalent group composed of a hydrocarbon group having 2 to 36 carbon atoms, a substituted hydrocarbon group having 3 to 58 carbon atoms, a heteroatom-containing hydrocarbon group having 2 to 36 carbon atoms, or a substituted heteroatom-containing hydrocarbon group having 2 to 58 carbon atoms, and these trivalent groups may have at least one cyclic structure, and these trivalent groups may have an unsaturated bond.

The hydrocarbon group having 2 to 36 carbon atoms is, for example, ethylene, propylene, butylene, pentene, hexene, heptene, octene, decene, dodecene, tetradecene, hexadecene, octadecene, eicosene, docosene, tetracosene, hexacosene, cyclopentane, cyclopentene, octahydro-1H-indene, 2,3,3a,4,7,7a-hexahydro-1H-indene, octahydro-1H-4,7-methanoindene, and the like, and the hydrocarbon group has preferably 2 to 28 carbon atoms, and more preferably 3 to 10 carbon atoms.

The substituted hydrocarbon group having 3 to 58 carbon atoms is a hydrocarbon group in which at least one hydrogen of the above hydrocarbon group having 2 to 36 carbon atoms is substituted with alkyl such as methyl, ethyl, propyl, butyl, pentyl, hexyl, heptyl, octyl, nonyl, decyl, isopropyl, isobutyl, sec-butyl, tert-butyl, isopentyl, neopentyl, isohexyl, tert-hexyl, 2-methylpentyl, 3-methylpentyl, 3,3-dimethylbutyl, isoheptyl, 3-methylhexyl, 2,2-dimethylpentyl, 3,3-dimethylpentyl, 2,3-dimethylpentyl, 2-ethylpentyl, 3-ethylpentyl, tert-heptyl, isooctyl, 2-methylheptyl, 3-methylheptyl, 4-methylheptyl, 2,2-dimethylhexyl, 3,3-dimethylhexyl, 2,3-dimethylhexyl, 2-ethylhexyl, 3-ethylhexyl, isononyl, 2-methyloctyl, 3-methyloctyl, 4-methyloctyl, 2,2-dimethylheptyl, 3,3-dimethylheptyl, 4,4-dimethylheptyl, 2,3-dimethylheptyl, 2,4-dimethylheptyl, 2,5-dimethylheptyl, 2,6-dimethylheptyl, 3,4-dimethylheptyl, 3,5-dimethylheptyl, 2-ethylheptyl, 3-ethylheptyl, 4-ethylheptyl, neononyl, isodecyl, 2-methylnonyl, 3-methylnonyl, 4-methylnonyl, 5-methylnonyl, 2,2-dimethyloctyl, 3,3-dimethyloctyl, 4,4-dimethyloctyl, 2,3-dimethyloctyl, 2,4-dimethyloctyl, 2,5-dimethyloctyl, 2,6-dimethyloctyl, 3,4-dimethyloctyl, 3,5-dimethyloctyl, 3,6-dimethyloctyl, 4,5-dimethyloctyl, 2-ethyloctyl, 3-ethyloctyl, 4-ethyloctyl, 3-propylheptyl, cyclobutyl, cyclopentyl, cyclohexyl, cycloheptyl, methylcyclohexyl, cyclooctyl, methylcycloheptyl, cyclononyl, methylcyclooctyl, cyclodecyl, and methylcyclononyl, and the substituted hydrocarbon group has preferably 3 to 48 carbon atoms, and more preferably 4 to 30 carbon atoms.

The heteroatom-containing hydrocarbon group having 2 to 36 carbon atoms is a hydrocarbon group in which at least one carbon of the above hydrocarbon group having 2 to 36 carbon atoms is substituted with a substituent containing a heteroatom such as a carbonyl group (>C—O), an amide group (—CONH₂, —CONH—, CON<), a sulfonyl group (>SO₂), a sulfide group (—S—), a thiocarbonyl group (>C═S), and a sulfoxy group (—S(═O)—), and the heteroatom-containing hydrocarbon group has preferably 2 to 28 carbon atoms, and more preferably 3 to 10 carbon atoms.

The substituted heteroatom-containing hydrocarbon group having 2 to 58 carbon atoms is a hydrocarbon group in which at least one carbon or hydrogen of the above hydrocarbon group having 2 to 36 carbon atoms is substituted with a substituent containing a heteroatom such as a hydroxy group (—OH), an alkoxy group (—OR), a carbonyl group (>C═O), a carboxy group (—COOH), an ester group (—COOR), an amino group (—NH₂), an imino group (═NH), an azo group (—N═N—), a nitro group (—NO₂), a nitroso group (—NO), an amide group (—CONH₂), a cyano group (—C≡N), a thiol group (—SH), a thioether group (—SR), a sulfonyl group (>SO₂), a sulfo group (—SO₃H), a sulfide group (—S—), a thiocarbonyl group (>C═S), and a sulfoxy group (—S(═O)—), and the substituted heteroatom-containing hydrocarbon group has preferably 3 to 48 carbon atoms, and more preferably 4 to 30 carbon atoms.

In formula (1), the monovalent alicyclic hydrocarbon group of A is more preferably a group represented by formula (4a), formula (4b), formula (4c), or formula (4d).

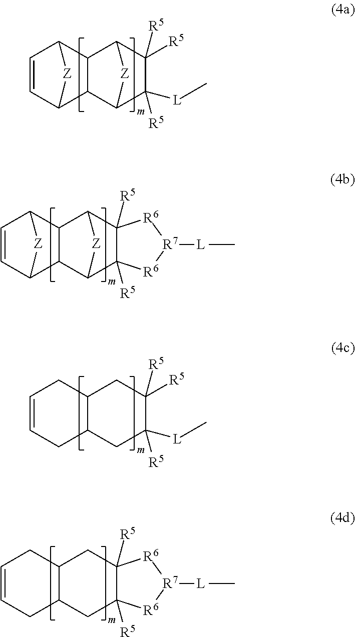

In formula (4a) to formula (4d), R⁵ is independently hydrogen or a monovalent hydrocarbon group having 1 to 4 carbon atoms, which may have an unsaturated bond, R⁶ is independently a divalent group composed of a hydrocarbon group having 1 to 4 carbon atoms, a substituted hydrocarbon group having 3 to 20 carbon atoms, a heteroatom-containing hydrocarbon group having 1 to 4 carbon atoms, or a substituted heteroatom-containing hydrocarbon group having 1 to 20 carbon atoms, and these divalent groups may have an unsaturated bond, R⁷ is methine (CH) or a trivalent hetero element, L is a divalent hydrocarbon group having 2 to 10 carbon atoms, which may have an unsaturated bond, Z is methylene or 1,2-ethanediyl, and m is an integer of 0 to 3.

The monovalent hydrocarbon group having 1 to 4 carbon atoms, which may have an unsaturated bond, in R⁵ is, for example, methyl, ethyl, propyl, butyl, isopropyl, isobutyl, tert-butyl, vinyl, allyl, butenyl, isopropenyl, isobutenyl, butadienyl, and the like.

The hydrocarbon group having 1 to 4 carbon atoms in R⁶ is, for example, methylene, 1,1-ethanediyl, 1,2-ethanediyl, 1,1-propanediyl, 1,2-propanediyl, 1,3-propanediyl, 1,1-butanediyl, 1,2-butanediyl, 1,3-butanediyl, 1,4-butanediyl, and the like.

The substituted hydrocarbon group having 3 to 20 carbon atoms is, for example, 2,2-propanediyl, 1-methylpropane-1,1-diyl, 1-methylpropane-1,2-diyl, 1-methylpropane-1,3-diyl, 2-methylpropane-1,1-diyl, 2-methylpropane-1,2-diyl, 2-methylpropane-1,3-diyl, 1,1-dimethylethane-1,2-diyl, 1-methylbutane-1,1-diyl, 1-methylbutane-1,2-diyl, 1-methylbutane-1,3-diyl, 1-methylbutane-1,4-diyl, 2-methylbutane-1,1-diyl, 2-methylbutane-1,2-diyl, 2-methylbutane-1,3-diyl, 2-methylbutane-1,4-diyl, 2,2-dimethylpropane-1,1-diyl, 2,2-dimethylpropane-1,3-diyl, 1-methylpentane-1,1-diyl, 1-methylpentane-1,2-diyl, 1-methylpentane-1,3-diyl, 1-methylpentane-1,4-diyl, 1-methylpentane-1,5-diyl, 2-methylpentane-1,1-diyl, 2-methylpentane-1,2-diyl, 2-methylpentane-1,3-diyl, 2-methylpentane-1,4-diyl, 2-methylpentane-1,5-diyl, 3-methylpentane-1,1-diyl, 3-methylpentane-1,2-diyl, 3-methylpentane-1,3-diyl, 3-methylpentane-1,4-diyl, 3-methylpentane-1,5-diyl, 1,1-dimethylbutane-1,2-diyl, 1,1-dimethylbutane-1,3-diyl, 1,1-dimethylbutane-1,4-diyl, 2,2-dimethylbutane-1,1-diyl, 2,2-dimethylbutane-1,3-diyl, 2,2-dimethylbutane-1,4-diyl, 1-methylhexane-1,1-diyl, 1-methylhexane-1,2-diyl, 1-methylhexane-1,3-diyl, 1-methylhexane-1,4-diyl, 1-methylhexane-1,5-diyl, 1-methylhexane-1,6-diyl, 2-methylhexane-1,1-diyl, 2-methylhexane-1,2-diyl, 2-methylhexane-1,3-diyl, 2-methylhexane-1,4-diyl, 2-methylhexane-1,5-diyl, 2-methylhexane-1,6-diyl, 3-methylhexane-1,1-diyl, 3-methylhexane-1,2-diyl, 3-methylhexane-1,3-diyl, 3-methylhexane-1,4-diyl, 3-methylhexane-1,5-diyl, 3-methylhexane-1,6-diyl, 1,1-dimethylpentane-1,2-diyl, 1,1-dimethylpentane-1,3-diyl, 1,1-dimethylpentane-1,4-diyl, 1,1-dimethylpentane-1,5-diyl, 2,2-dimethylpentane-1,1-diyl, 2,2-dimethylpentane-1,3-diyl, 2,2-dimethylpentane-1,4-diyl, 2,2-dimethylpentane-1,5-diyl, 3,3-dimethylpentane-1,1-diyl, 3,3-dimethylpentane-1,2-diyl, 3,3-dimethylpentane-1,4-diyl, 3,3-dimethylpentane-1,5-diyl, 1-ethylpentane-1,1-diyl, 1-ethylpentane-1,2-diyl, 1-ethylpentane-1,3-diyl, 1-ethylpentane-1,4-diyl, 1-ethylpentane-1,5-diyl, 2-ethylpentane-1,1-diyl, 2-ethylpentane-1,2-diyl, 2-ethylpentane-1,3-diyl, 2-ethylpentane-1,4-diyl, 2-ethylpentane-1,5-diyl, 3-ethylpentane-1,1-diyl, 3-ethylpentane-1,2-diyl, 3-ethylpentane-1,3-diyl, 3-ethylpentane-1,4-diyl, 3-ethylpentane-1,5-diyl, 1,1-dimethylpentane-1,2-diyl, 1,1-dimethylpentane-1,3-diyl, 1,1-dimethylpentane-1,4-diyl, 1,1-dimethylpentane-1,5-diyl, 2,2-dimethylpentane-1,1-diyl, 2,2-dimethylpentane-1,3-diyl, 2,2-dimethylpentane-1,4-diyl, 2,2-dimethylpentane-1,5-diyl, 3,3-dimethylpentane-1,1-diyl, 3,3-dimethylpentane-1,2-diyl, 3,3-dimethylpentane-1,4-diyl, 3,3-dimethylpentane-1,5-diyl, 1-methylheptane-1,1-diyl, 1-methylheptane-1,2-diyl, 1-methylheptane-1,3-diyl, 1-methylheptane-1,4-diyl, 1-methylheptane-1,5-diyl, 1-methylheptane-1,6-diyl, 1-methylheptane-1,7-diyl, 2-methylheptane-1,1-diyl, 2-methylheptane-1,2-diyl, 2-methylheptane-1,3-diyl, 2-methylheptane-1,4-diyl, 2-methylheptane-1,5-diyl, 2-methylheptane-1,6-diyl, 2-methylheptane-1,7-diyl, 3-methylheptane-1,1-diyl, 3-methylheptane-1,2-diyl, 3-methylheptane-1,3-diyl, 3-methylheptane-1,4-diyl, 3-methylheptane-1,5-diyl, 3-methylheptane-1,6-diyl, 3-methylheptane-1,7-diyl, 4-methylheptane-1,1-diyl, 4-methylheptane-1,2-diyl, 4-methylheptane-1,3-diyl, 4-methylheptane-1,4-diyl, 4-methylheptane-1,5-diyl, 4-methylheptane-1,6-diyl, 4-methylheptane-1,7-diyl, 1,1-dimethylhexane-1,2-diyl, 1,1-dimethylhexane-1,3-diyl, 1,1-dimethylhexane-1,4-diyl, 1,1-dimethylhexane-1,5-diyl, 1,1-dimethylhexane-1,6-diyl, 2,2-dimethylhexane-1,1-diyl, 2,2-dimethylhexane-1,3-diyl, 2,2-dimethylhexane-1,4-diyl, 2,2-dimethylhexane-1,5-diyl, 2,2-dimethylhexane-1,6-diyl, 3,3-dimethylhexane-1,1-diyl, 3,3-dimethylhexane-1,2-diyl, 3,3-dimethylhexane-1,4-diyl, 3,3-dimethylhexane-1,5-diyl, 3,3-dimethylhexane-1,6-diyl, 1-ethylhexane-1,1-diyl, 1-ethylhexane-1,2-diyl, 1-ethylhexane-1,3-diyl, 1-ethylhexane-1,4-diyl, 1-ethylhexane-1,5-diyl, 1-ethylhexane-1,6-diyl, 2-ethylhexane-1,1-diyl, 2-ethylhexane-1,2-diyl, 2-ethylhexane-1,3-diyl, 2-ethylhexane-1,4-diyl, 2-ethylhexane-1,5-diyl, 2-ethylhexane-1,6-diyl, 3-ethylhexane-1,1-diyl, 3-ethylhexane-1,2-diyl, 3-ethylhexane-1,3-diyl, 3-ethylhexane-1,4-diyl, 3-ethylhexane-1,5-diyl, 3-ethylhexane-1,6-diyl, 1-methyloctane-1,1-diyl, 1-methyloctane-1,2-diyl, 1-methyloctane-1,3-diyl, 1-methyloctane-1,4-diyl, 1-methyloctane-1,5-diyl, 1-methyloctane-1,6-diyl, 1-methyloctane-1,7-diyl, 1-methyloctane-1,8-diyl, 2-methyloctane-1,1-diyl, 2-methyloctane-1,2-diyl, 2-methyloctane-1,3-diyl, 2-methyloctane-1,4-diyl, 2-methyloctane-1,5-diyl, 2-methyloctane-1,6-diyl, 2-methyloctane-1,7-diyl, 2-methyloctane-1,8-diyl, 3-methyloctane-1,1-diyl, 3-methyloctane-1,2-diyl, 3-methyloctane-1,3-diyl, 3-methyloctane-1,4-diyl, 3-methyloctane-1,5-diyl, 3-methyloctane-1,6-diyl, 3-methyloctane-1,7-diyl, 3-methyloctane-1,8-diyl, 4-methyloctane-1,1-diyl, 4-methyloctane-1,2-diyl, 4-methyloctane-1,3-diyl, 4-methyloctane-1,4-diyl, 4-methyloctane-1,5-diyl, 4-methyloctane-1,6-diyl, 4-methyloctane-1,7-diyl, 4-methyloctane-1,8-diyl, 1,1-dimethylheptane-1,2-diyl, 1,1-dimethylheptane-1,3-diyl, 1,1-dimethylheptane-1,4-diyl, 1,1-dimethylheptane-1,5-diyl, 1,1-dimethylheptane-1,6-diyl, 1,1-dimethylheptane-1,7-diyl, 2,2-dimethylheptane-1,1-diyl, 2,2-dimethylheptane-1,3-diyl, 2,2-dimethylheptane-1,4-diyl, 2,2-dimethylheptane-1,5-diyl, 2,2-dimethylheptane-1,6-diyl, 2,2-dimethylheptane-1,7-diyl, 3,3-dimethylheptane-1,1-diyl, 3,3-dimethylheptane-1,2-diyl, 3,3-dimethylheptane-1,4-diyl, 3,3-dimethylheptane-1,5-diyl, 3,3-dimethylheptane-1,6-diyl, 3,3-dimethylheptane-1,7-diyl, 4,4-dimethylheptane-1,1-diyl, 4,4-dimethylheptane-1,2-diyl, 4,4-dimethylheptane-1,3-diyl, 4,4-dimethylheptane-1,5-diyl, 4,4-dimethylheptane-1,6-diyl, 4,4-dimethylheptane-1,7-diyl, 1-ethylheptane-1,1-diyl, 1-ethylheptane-1,2-diyl, 1-ethylheptane-1,3-diyl, 1-ethylheptane-1,4-diyl, 1-ethylheptane-1,5-diyl, 1-ethylheptane-1,6-diyl, 1-ethylheptane-1,7-diyl, 2-ethylheptane-1,1-diyl, 2-ethylheptane-1,2-diyl, 2-ethylheptane-1,3-diyl, 2-ethylheptane-1,4-diyl, 2-ethylheptane-1,5-diyl, 2-ethylheptane-1,6-diyl, 2-ethylheptane-1,7-diyl, 3-ethylheptane-1,1-diyl, 3-ethylheptane-1,2-diyl, 3-ethylheptane-1,3-diyl, 3-ethylheptane-1,4-diyl, 3-ethylheptane-1,5-diyl, 3-ethylheptane-1,6-diyl, 3-ethylheptane-1,7-diyl, 4-ethylheptane-1,1-diyl, 4-ethylheptane-1,2-diyl, 4-ethylheptane-1,3-diyl, 4-ethylheptane-1,4-diyl, 4-ethylheptane-1,5-diyl, 4-ethylheptane-1,6-diyl, 4-ethylheptane-1,7-diyl, 2,2,4,4-tetramethylpentane-1,5-diyl, 1-methylnonane-1,1-diyl, 1-methylnonane-1,2-diyl, 1-methylnonane-1,3-diyl, 1-methylnonane-1,4-diyl, 1-methylnonane-1,5-diyl, 1-methylnonane-1,6-diyl, 1-methylnonane-1,7-diyl, 1-methylnonane-1,8-diyl, 1-methylnonane-1,9-diyl, 2-methylnonane-1,1-diyl, 2-methylnonane-1,2-diyl, 2-methylnonane-1,3-diyl, 2-methylnonane-1,4-diyl, 2-methylnonane-1,5-diyl, 2-methylnonane-1,6-diyl, 2-methylnonane-1,7-diyl, 2-methylnonane-1,8-diyl, 2-methylnonane-1,9-diyl, 3-methylnonane-1,1-diyl, 3-methylnonane-1,2-diyl, 3-methylnonane-1,3-diyl, 3-methylnonane-1,4-diyl, 3-methylnonane-1,5-diyl, 3-methylnonane-1,6-diyl, 3-methylnonane-1,7-diyl, 3-methylnonane-1,8-diyl, 3-methylnonane-1,9-diyl, 4-methylnonane-1,1-diyl, 4-methylnonane-1,2-diyl, 4-methylnonane-1,3-diyl, 4-methylnonane-1,4-diyl, 4-methylnonane-1,5-diyl, 4-methylnonane-1,6-diyl, 4-methylnonane-1,7-diyl, 4-methylnonane-1,8-diyl, 4-methylnonane-1,9-diyl, 5-methylnonane-1,1-diyl, 5-methylnonane-1,2-diyl, 5-methylnonane-1,3-diyl, 5-methylnonane-1,4-diyl, 5-methylnonane-1,5-diyl, 5-methylnonane-1,6-diyl, 5-methylnonane-1,7-diyl, 5-methylnonane-1,8-diyl, 5-methylnonane-1,9-diyl, 1,1-dimethyloctane-1,2-diyl, 1,1-dimethyloctane-1,3-diyl, 1,1-dimethyloctane-1,4-diyl, 1,1-dimethyloctane-1,5-diyl, 1,1-dimethyloctane-1,6-diyl, 1,1-dimethyloctane-1,7-diyl, 1,1-dimethyloctane-1,8-diyl, 2,2-dimethyloctane-1,1-diyl, 2,2-dimethyloctane-1,3-diyl, 2,2-dimethyloctane-1,4-diyl, 2,2-dimethyloctane-1,5-diyl, 2,2-dimethyloctane-1,6-diyl, 2,2-dimethyloctane-1,7-diyl, 2,2-dimethyloctane-1,8-diyl, 3,3-dimethyloctane-1,1-diyl, 3,3-dimethyloctane-1,2-diyl, 3,3-dimethyloctane-1,4-diyl, 3,3-dimethyloctane-1,5-diyl, 3,3-dimethyloctane-1,6-diyl, 3,3-dimethyloctane-1,7-diyl, 3,3-dimethyloctane-1,8-diyl, 4,4-dimethyloctane-1,1-diyl, 4,4-dimethyloctane-1,2-diyl, 4,4-dimethyloctane-1,3-diyl, 4,4-dimethyloctane-1,5-diyl, 4,4-dimethyloctane-1,6-diyl, 4,4-dimethyloctane-1,7-diyl, 4,4-dimethyloctane-1,8-diyl, 1-ethyloctane-1,1-diyl, 1-ethyloctane-1,2-diyl, 1-ethyloctane-1,3-diyl, 1-ethyloctane-1,4-diyl, 1-ethyloctane-1,5-diyl, 1-ethyloctane-1,6-diyl, 1-ethyloctane-1,7-diyl, 1-ethyloctane-1,8-diyl, 2-ethyloctane-1,1-diyl, 2-ethyloctane-1,2-diyl, 2-ethyloctane-1,3-diyl, 2-ethyloctane-1,4-diyl, 2-ethyloctane-1,5-diyl, 2-ethyloctane-1,6-diyl, 2-ethyloctane-1,7-diyl, 2-ethyloctane-1,8-diyl, 3-ethyloctane-1,1-diyl, 3-ethyloctane-1,2-diyl, 3-ethyloctane-1,3-diyl, 3-ethyloctane-1,4-diyl, 3-ethyloctane-1,5-diyl, 3-ethyloctane-1,6-diyl, 3-ethyloctane-1,7-diyl, 3-ethyloctane-1,8-diyl, 4-ethyloctane-1,1-diyl, 4-ethyloctane-1,2-diyl, 4-ethyloctane-1,3-diyl, 4-ethyloctane-1,4-diyl, 4-ethyloctane-1,5-diyl, 4-ethyloctane-1,6-diyl, 4-ethyloctane-1,7-diyl, 4-ethyloctane-1,8-diyl, and the like, and the substituted hydrocarbon group has preferably 3 to 10 carbon atoms, and more preferably 3 to 6 carbon atoms.

The heteroatom-containing hydrocarbon group having 1 to 4 carbon atoms is, for example, a hydrocarbon group in which at least one carbon of a hydrocarbon group such as methylene, 1,1-ethanediyl, 1,2-ethanediyl, 1,1-propanediyl, 1,2-propanediyl, 1,3-propanediyl, 1,1-butanediyl, 1,2-butanediyl, 1,3-butanediyl, and 1,4-butanediyl is substituted with a substituent containing a heteroatom such as a carbonyl group (>C═O), an amide group (—CONH₂, —CONH—, CON<), a sulfonyl group (>SO₂), a sulfide group (—S—), a thiocarbonyl group (>C═S), and a sulfoxy group (—S(═O)—).

The substituted heteroatom-containing hydrocarbon group having 1 to 20 carbon atoms is, for example, a hydrocarbon group in which at least one carbon or hydrogen of a hydrocarbon group such as methylene, 1,1-ethanediyl, 1,2-ethanediyl, 1,1-propanediyl, 1,2-propanediyl, 1,3-propanediyl, 1,1-butanediyl, 1,2-butanediyl, 1,3-butanediyl, and 1,4-butanediyl is substituted with a substituent containing a heteroatom such as a hydroxy group (—OH), an alkoxy group (—OR), a carbonyl group (>C═O), a carboxy group (—COOH), an ester group (—COOR), an amino group (—NH₂), an imino group (═NH), an azo group (—N═N—), a nitro group (—NO₂), a nitroso group (—NO), an amide group (—CONH₂), a cyano group (—C≡N), a thiol group (—SH), a thioether group (—SR), a sulfonyl group (>SO₂), a sulfo group (—SO₃H), a sulfide group (—S—), a thiocarbonyl group (>C═S), and a sulfoxy group (—S(═O)—), and the substituted heteroatom-containing hydrocarbon group has preferably 1 to 10 carbon atoms, and more preferably 1 to 4 carbon atoms.

In the group represented by formula (4b) or formula (4d), the number of ring members including two R⁶ and R⁷ is 5 or more, preferably 5 to 15, more preferably 5 to 7, and particularly preferably 5.

The divalent hydrocarbon group having 2 to 10 carbon atoms, which may have an unsaturated bond, in L is, for example, 1,2-ethanediyl, prop-1-ene-1,2-diyl, prop-1-ene-1,3-diyl, prop-1-ene-2,3-diyl, but-1-ene-1,2-diyl, but-1-ene-1,3-diyl, but-1-ene-1,4-diyl, but-1-ene-2,3-diyl, but-1-ene-2,4-diyl, but-1-ene-3,4-diyl, but-2-ene-1,2-diyl, but-2-ene-1,3-diyl, but-2-ene-1,4-diyl, but-2-ene-2,3-diyl, but-2-ene-2,4-diyl, but-2-ene-3,4-diyl, pent-1-ene-1,2-diyl, pent-1-ene-1,3-diyl, pent-1-ene-1,4-diyl, pent-1-ene-1,5-diyl, pent-1-ene-2,3-diyl, pent-1-ene-2,4-diyl, pent-1-ene-2,5-diyl, pent-2-ene-3,4-diyl, pent-1-ene-3,5-diyl, pent-1-ene-4,5-diyl, pent-2-ene-1,2-diyl, pent-2-ene-1,3-diyl, pent-2-ene-1,4-diyl, pent-2-ene-1,5-diyl, pent-2-ene-2,3-diyl, pent-2-ene-2,4-diyl, pent-2-ene-2,5-diyl, pent-2-ene-3,4-diyl, pent-2-ene-3,5-diyl, pent-2-ene-4,5-diyl, hexa-1-ene-1,2-diyl, hexa-1-ene-1,3-diyl, hexa-1-ene-1,4-diyl, hexa-1-ene-1,5-diyl, hexa-1-ene-1,6-diyl, hexa-1-ene-2,3-diyl, hexa-1-ene-2,4-diyl, hexa-1-ene-2,5-diyl, hexa-1-ene-2,6-diyl, hexa-1-ene-3,4-diyl, hexa-1-ene-3,5-diyl, hexa-1-ene-3,6-diyl, hexa-1-ene-4,5-diyl, hexa-1-ene-4,6-diyl, hexa-1-ene-5,6-diyl, hexa-2-ene-1,2-diyl, hexa-2-ene-1,3-diyl, hexa-2-ene-1,4-diyl, hexa-2-ene-1,5-diyl, hexa-2-ene-1,6-diyl, hexa-2-ene-2,3-diyl, hexa-2-ene-2,4-diyl, hexa-2-ene-2,5-diyl, hexa-2-ene-2,6-diyl, hexa-2-ene-3,4-diyl, hexa-2-ene-3,5-diyl, hexa-2-ene-3,6-diyl, hexa-2-ene-4,5-diyl, hexa-2-ene-4,6-diyl, hexa-2-ene-5,6-diyl, hexa-3-ene-1,2-diyl, hexa-3-ene-1,3-diyl, hexa-3-ene-1,4-diyl, hexa-3-ene-1,5-diyl, hexa-3-ene-1,6-diyl, hexa-3-ene-2,3-diyl, hexa-3-ene-2,4-diyl, hexa-3-ene-2,5-diyl, hexa-3-ene-2,6-diyl, hexa-3-ene-3,4-diyl, hexa-3-ene-3,5-diyl, hexa-3-ene-3,6-diyl, hexa-3-ene-4,5-diyl, hexa-3-ene-4,6-diyl, hexa-3-ene-5,6-diyl, hepta-1-ene-1,2-diyl, hepta-1-ene-1,3-diyl, hepta-1-ene-1,4-diyl, hepta-1-ene-1,5-diyl, hepta-1-ene-1,6-diyl, hepta-1-ene-1,7-diyl, hepta-1-ene-2,3-diyl, hepta-1-ene-2,4-diyl, hepta-1-ene-2,5-diyl, hepta-1-ene-2,6-diyl, hepta-1-ene-2,7-diyl, hepta-1-ene-3,4-diyl, hepta-1-ene-3,5-diyl, hepta-1-ene-3,6-diyl, hepta-1-ene-3,7-diyl, hepta-1-ene-4,5-diyl, hepta-1-ene-4,6-diyl, hepta-1-ene-4,7-diyl, hepta-1-ene-5,6-diyl, hepta-1-ene-5,7-diyl, hepta-1-ene-6,7-diyl, hepta-2-ene-1,2-diyl, hepta-2-ene-1,3-diyl, hepta-2-ene-1,4-diyl, hepta-2-ene-1,5-diyl, hepta-2-ene-1,6-diyl, hepta-2-ene-1,7-diyl, hepta-2-ene-2,3-diyl, hepta-2-ene-2,4-diyl, hepta-2-ene-2,5-diyl, hepta-2-ene-2,6-diyl, hepta-2-ene-2,7-diyl, hepta-2-ene-3,4-diyl, hepta-2-ene-3,5-diyl, hepta-2-ene-3,6-diyl, hepta-2-ene-3,7-diyl, hepta-2-ene-4,5-diyl, hepta-2-ene-4,6-diyl, hepta-2-ene-4,7-diyl, hepta-2-ene-5,6-diyl, hepta-2-ene-5,7-diyl, hepta-2-ene-6,7-diyl, hepta-3-ene-1,2-diyl, hepta-3-ene-1,3-diyl, hepta-3-ene-1,4-diyl, hepta-3-ene-1,5-diyl, hepta-3-ene-1,6-diyl, hepta-3-ene-1,7-diyl, hepta-3-ene-2,3-diyl, hepta-3-ene-2,4-diyl, hepta-3-ene-2,5-diyl, hepta-3-ene-2,6-diyl, hepta-3-ene-2,7-diyl, hepta-3-ene-3,4-diyl, hepta-3-ene-3,5-diyl, hepta-3-ene-3,6-diyl, hepta-3-ene-3,7-diyl, hepta-3-ene-4,5-diyl, hepta-3-ene-4,6-diyl, hepta-3-ene-4,7-diyl, hepta-3-ene-5,6-diyl, hepta-3-ene-5,7-diyl, hepta-3-ene-6,7-diyl, octa-1-ene-1,2-diyl, octa-1-ene-1,3-diyl, octa-1-ene-1,4-diyl, octa-1-ene-1,5-diyl, octa-1-ene-1,6-diyl, octa-1-ene-1,7-diyl, octa-1-ene-1,8-diyl, octa-1-ene-2,3-diyl, octa-1-ene-2,4-diyl, octa-1-ene-2,5-diyl, octa-1-ene-2,6-diyl, octa-1-ene-2,7-diyl, octa-1-ene-2,8-diyl, octa-1-ene-3,4-diyl, octa-1-ene-3,5-diyl, octa-1-ene-3,6-diyl, octa-1-ene-3,7-diyl, octa-1-ene-3,8-diyl, octa-1-ene-4,5-diyl, octa-1-ene-4,6-diyl, octa-1-ene-4,7-diyl, octa-1-ene-4,8-diyl, octa-1-ene-5,6-diyl, octa-1-ene-5,7-diyl, octa-1-ene-5,8-diyl, octa-1-ene-6,7-diyl, octa-1-ene-6,8-diyl, octa-1-ene-7,8-diyl, octa-2-ene-1,2-diyl, octa-2-ene-1,3-diyl, octa-2-ene-1,4-diyl, octa-2-ene-1,5-diyl, octa-2-ene-1,6-diyl, octa-2-ene-1,7-diyl, octa-2-ene-1,8-diyl, octa-2-ene-2,3-diyl, octa-2-ene-2,4-diyl, octa-2-ene-2,5-diyl, octa-2-ene-2,6-diyl, octa-2-ene-2,7-diyl, octa-2-ene-2,8-diyl, octa-2-ene-3,4-diyl, octa-2-ene-3,5-diyl, octa-2-ene-3,6-diyl, octa-2-ene-3,7-diyl, octa-2-ene-3,8-diyl, octa-2-ene-4,5-diyl, octa-2-ene-4,6-diyl, octa-2-ene-4,7-diyl, octa-2-ene-4,8-diyl, octa-2-ene-5,6-diyl, octa-2-ene-5,7-diyl, octa-2-ene-5,8-diyl, octa-2-ene-6,7-diyl, octa-2-ene-6,8-diyl, octa-2-ene-7,8-diyl, octa-3-ene-1,2-diyl, octa-3-ene-1,3-diyl, octa-3-ene-1,4-diyl, octa-3-ene-1,5-diyl, octa-3-ene-1,6-diyl, octa-3-ene-1,7-diyl, octa-3-ene-1,8-diyl, octa-3-ene-2,3-diyl, octa-3-ene-2,4-diyl, octa-3-ene-2,5-diyl, octa-3-ene-2,6-diyl, octa-3-ene-2,7-diyl, octa-3-ene-2,8-diyl, octa-3-ene-3,4-diyl, octa-3-ene-3,5-diyl, octa-3-ene-3,6-diyl, octa-3-ene-3,7-diyl, octa-3-ene-3,8-diyl, octa-3-ene-4,5-diyl, octa-3-ene-4,6-diyl, octa-3-ene-4,7-diyl, octa-3-ene-4,8-diyl, octa-3-ene-5,6-diyl, octa-3-ene-5,7-diyl, octa-3-ene-5,8-diyl, octa-3-ene-6,7-diyl, octa-3-ene-6,8-diyl, octa-3-ene-7,8-diyl, octa-4-ene-1,2-diyl, octa-4-ene-1,3-diyl, octa-4-ene-1,4-diyl, octa-4-ene-1,5-diyl, octa-4-ene-1,6-diyl, octa-4-ene-1,7-diyl, octa-4-ene-1,8-diyl, octa-4-ene-2,4-diyl, octa-4-ene-2,5-diyl, octa-4-ene-2,6-diyl, octa-4-ene-2,7-diyl, octa-4-ene-2,8-diyl, octa-4-ene-3,4-diyl, octa-4-ene-3,5-diyl, octa-4-ene-3,6-diyl, octa-4-ene-3,7-diyl, octa-4-ene-3,8-diyl, octa-4-ene-4,5-diyl, octa-4-ene-4,6-diyl, octa-4-ene-4,7-diyl, octa-4-ene-4,8-diyl, octa-4-ene-5,6-diyl, octa-4-ene-5,7-diyl, octa-4-ene-5,8-diyl, octa-4-ene-6,7-diyl, octa-4-ene-6,8-diyl, octa-4-ene-7,8-diyl, nona-1-ene-1,2-diyl, nona-1-ene-1,3-diyl, nona-1-ene-1,4-diyl, nona-1-ene-1,5-diyl, nona-1-ene-1,6-diyl, nona-1-ene-1,7-diyl, nona-1-ene-1,8-diyl, nona-1-ene-1,9-diyl, nona-1-ene-2,3-diyl, nona-1-ene-2,4-diyl, nona-1-ene-2,5-diyl, nona-1-ene-2,6-diyl, nona-1-ene-2,7-diyl, nona-1-ene-2,8-diyl, nona-1-ene-2,9-diyl, nona-1-ene-3,4-diyl, nona-1-ene-3,5-diyl, nona-1-ene-3,6-diyl, nona-1-ene-3,7-diyl, nona-1-ene-3,8-diyl, nona-1-ene-3,9-diyl, nona-1-ene-4,5-diyl, nona-1-ene-4,6-diyl, nona-1-ene-4,7-diyl, nona-1-ene-4,8-diyl, nona-1-ene-4,9-diyl, nona-1-ene-5,6-diyl, nona-1-ene-5,7-diyl, nona-1-ene-5,8-diyl, nona-1-ene-5,9-diyl, nona-1-ene-6,7-diyl, nona-1-ene-6,8-diyl, nona-1-ene-6,9-diyl, nona-1-ene-7,8-diyl, nona-1-ene-7,9-diyl, nona-1-ene-8,9-diyl, nona-2-ene-1,2-diyl, nona-2-ene-1,3-diyl, nona-2-ene-1,4-diyl, nona-2-ene-1,5-diyl, nona-2-ene-1,6-diyl, nona-2-ene-1,7-diyl, nona-2-ene-1,8-diyl, nona-2-ene-1,9-diyl, nona-2-ene-2,3-diyl, nona-2-ene-2,4-diyl, nona-2-ene-2,5-diyl, nona-2-ene-2,6-diyl, nona-2-ene-2,7-diyl, nona-2-ene-2,8-diyl, nona-2-ene-2,9-diyl, nona-2-ene-3,4-diyl, nona-2-ene-3,5-diyl, nona-2-ene-3,6-diyl, nona-2-ene-3,7-diyl, nona-2-ene-3,8-diyl, nona-2-ene-3,9-diyl, nona-2-ene-4,5-diyl, nona-2-ene-4,6-diyl, nona-2-ene-4,7-diyl, nona-2-ene-4,8-diyl, nona-2-ene-4,9-diyl, nona-2-ene-5,6-diyl, nona-2-ene-5,7-diyl, nona-2-ene-5,8-diyl, nona-2-ene-5,9-diyl, nona-2-ene-6,7-diyl, nona-2-ene-6,8-diyl, nona-2-ene-6,9-diyl, nona-2-ene-7,8-diyl, nona-2-ene-7,9-diyl, nona-2-ene-8,9-diyl, nona-3-ene-1,2-diyl, nona-3-ene-1,3-diyl, nona-3-ene-1,4-diyl, nona-3-ene-1,5-diyl, nona-3-ene-1,6-diyl, nona-3-ene-1,7-diyl, nona-3-ene-1,8-diyl, nona-3-ene-1,9-diyl, nona-3-ene-2,3-diyl, nona-3-ene-2,4-diyl, nona-3-ene-2,5-diyl, nona-3-ene-2,6-diyl, nona-3-ene-2,7-diyl, nona-3-ene-2,8-diyl, nona-3-ene-2,9-diyl, nona-3-ene-3,4-diyl, nona-3-ene-3,5-diyl, nona-3-ene-3,6-diyl, nona-3-ene-3,7-diyl, nona-3-ene-3,8-diyl, nona-3-ene-3,9-diyl, nona-3-ene-4,5-diyl, nona-3-ene-4,6-diyl, nona-3-ene-4,7-diyl, nona-3-ene-4,8-diyl, nona-3-ene-4,9-diyl, nona-3-ene-5,6-diyl, nona-3-ene-5,7-diyl, nona-3-ene-5,8-diyl, nona-3-ene-5,9-diyl, nona-3-ene-6,7-diyl, nona-3-ene-6,8-diyl, nona-3-ene-6,9-diyl, nona-3-ene-7,8-diyl, nona-3-ene-7,9-diyl, nona-3-ene-8,9-diyl, nona-4-ene-1,2-diyl, nona-4-ene-1,3-diyl, nona-4-ene-1,4-diyl, nona-4-ene-1,5-diyl, nona-4-ene-1,6-diyl, nona-4-ene-1,7-diyl, nona-4-ene-1,8-diyl, nona-4-ene-1,9-diyl, nona-4-ene-2,3-diyl, nona-4-ene-2,4-diyl, nona-4-ene-2,5-diyl, nona-4-ene-2,6-diyl, nona-4-ene-2,7-diyl, nona-4-ene-2,8-diyl, nona-4-ene-2,9-diyl, nona-4-ene-3,4-diyl, nona-4-ene-3,5-diyl, nona-4-ene-3,6-diyl, nona-4-ene-3,7-diyl, nona-4-ene-3,8-diyl, nona-4-ene-3,9-diyl, nona-4-ene-4,5-diyl, nona-4-ene-4,6-diyl, nona-4-ene-4,7-diyl, nona-4-ene-4,8-diyl, nona-4-ene-4,9-diyl, nona-4-ene-5,6-diyl, nona-4-ene-5,7-diyl, nona-4-ene-5,8-diyl, nona-4-ene-5,9-diyl, nona-4-ene-6,7-diyl, nona-4-ene-6,8-diyl, nona-4-ene-6,9-diyl, nona-4-ene-7,8-diyl, nona-4-ene-7,9-diyl, nona-4-ene-8,9-diyl, deca-1-ene-1,2-diyl, deca-1-ene-1,3-diyl, deca-1-ene-1,4-diyl, deca-1-ene-1,5-diyl, deca-1-ene-1,6-diyl, deca-1-ene-1,7-diyl, deca-1-ene-1,8-diyl, deca-1-ene-1,9-diyl, deca-1-ene-1,10-diyl, deca-1-ene-2,3-diyl, deca-1-ene-2,4-diyl, deca-1-ene-2,5-diyl, deca-1-ene-2,6-diyl, deca-1-ene-2,7-diyl, deca-1-ene-2,8-diyl, deca-1-ene-2,9-diyl, deca-1-ene-2,10-diyl, deca-1-ene-3,4-diyl, deca-1-ene-3,5-diyl, deca-1-ene-3,6-diyl, deca-1-ene-3,7-diyl, deca-1-ene-3,8-diyl, deca-1-ene-3,9-diyl, deca-1-ene-3,10-diyl, deca-1-ene-4,5-diyl, deca-1-ene-4,6-diyl, deca-1-ene-4,7-diyl, deca-1-ene-4,8-diyl, deca-1-ene-4,9-diyl, deca-1-ene-4,10-diyl, deca-1-ene-5,6-diyl, deca-1-ene-5,7-diyl, deca-1-ene-5,8-diyl, deca-1-ene-5,9-diyl, deca-1-ene-5,10-diyl, deca-1-ene-6,7-diyl, deca-1-ene-6,8-diyl, deca-1-ene-6,9-diyl, deca-1-ene-6,10-diyl, deca-1-ene-7,8-diyl, deca-1-ene-7,9-diyl, deca-1-ene-7,10-diyl, deca-1-ene-8,9-diyl, deca-1-ene-8,10-diyl, deca-1-ene-9,10-diyl, deca-2-ene-1,2-diyl, deca-2-ene-1,3-diyl, deca-2-ene-1,4-diyl, deca-2-ene-1,5-diyl, deca-2-ene-1,6-diyl, deca-2-ene-1,7-diyl, deca-2-ene-1,8-diyl, deca-2-ene-1,9-diyl, deca-2-ene-1,10-diyl, deca-2-ene-2,3-diyl, deca-2-ene-2,4-diyl, deca-2-ene-2,5-diyl, deca-2-ene-2,6-diyl, deca-2-ene-2,7-diyl, deca-2-ene-2,8-diyl, deca-2-ene-2,9-diyl, deca-2-ene-2,10-diyl, deca-2-ene-3,4-diyl, deca-2-ene-3,5-diyl, deca-2-ene-3,6-diyl, deca-2-ene-3,7-diyl, deca-2-ene-3,8-diyl, deca-2-ene-3,9-diyl, deca-2-ene-3,10-diyl, deca-2-ene-4,5-diyl, deca-2-ene-4,6-diyl, deca-2-ene-4,7-diyl, deca-2-ene-4,8-diyl, deca-2-ene-4,9-diyl, deca-2-ene-4,10-diyl, deca-2-ene-5,6-diyl, deca-2-ene-5,7-diyl, deca-2-ene-5,8-diyl, deca-2-ene-5,9-diyl, deca-2-ene-5,10-diyl, deca-2-ene-6,7-diyl, deca-2-ene-6,8-diyl, deca-2-ene-6,9-diyl, deca-2-ene-6,10-diyl, deca-2-ene-7,8-diyl, deca-2-ene-7,9-diyl, deca-2-ene-7,10-diyl, deca-2-ene-8,9-diyl, deca-2-ene-8,10-diyl, deca-2-ene-9,10-diyl, deca-3-ene-1,2-diyl, deca-3-ene-1,3-diyl, deca-3-ene-1,4-diyl, deca-3-ene-1,5-diyl, deca-3-ene-1,6-diyl, deca-3-ene-1,7-diyl, deca-3-ene-1,8-diyl, deca-3-ene-1,9-diyl, deca-3-ene-1,10-diyl, deca-3-ene-2,3-diyl, deca-3-ene-2,4-diyl, deca-3-ene-2,5-diyl, deca-3-ene-2,6-diyl, deca-3-ene-2,7-diyl, deca-3-ene-2,8-diyl, deca-3-ene-2,9-diyl, deca-3-ene-2,10-diyl, deca-3-ene-3,4-diyl, deca-3-ene-3,5-diyl, deca-3-ene-3,6-diyl, deca-3-ene-3,7-diyl, deca-3-ene-3,8-diyl, deca-3-ene-3,9-diyl, deca-3-ene-3,10-diyl, deca-3-ene-4,5-diyl, deca-3-ene-4,6-diyl, deca-3-ene-4,7-diyl, deca-3-ene-4,8-diyl, deca-3-ene-4,9-diyl, deca-3-ene-4,10-diyl, deca-3-ene-5,6-diyl, deca-3-ene-5,7-diyl, deca-3-ene-5,8-diyl, deca-3-ene-5,9-diyl, deca-3-ene-5,10-diyl, deca-3-ene-6,7-diyl, deca-3-ene-6,8-diyl, deca-3-ene-6,9-diyl, deca-3-ene-6,10-diyl, deca-3-ene-7,8-diyl, deca-3-ene-7,9-diyl, deca-3-ene-7,10-diyl, deca-3-ene-8,9-diyl, deca-3-ene-8,10-diyl, deca-3-ene-9,10-diyl, deca-4-ene-1,2-diyl, deca-4-ene-1,3-diyl, deca-4-ene-1,4-diyl, deca-4-ene-1,5-diyl, deca-4-ene-1,6-diyl, deca-4-ene-1,7-diyl, deca-4-ene-1,8-diyl, deca-4-ene-1,9-diyl, deca-4-ene-1,10-diyl, deca-4-ene-2,3-diyl, deca-4-ene-2,4-diyl, deca-4-ene-2,5-diyl, deca-4-ene-2,6-diyl, deca-4-ene-2,7-diyl, deca-4-ene-2,8-diyl, deca-4-ene-2,9-diyl, deca-4-ene-2,10-diyl, deca-4-ene-3,4-diyl, deca-4-ene-3,5-diyl, deca-4-ene-3,6-diyl, deca-4-ene-3,7-diyl, deca-4-ene-3,8-diyl, deca-4-ene-3,9-diyl, deca-4-ene-3,10-diyl, deca-4-ene-4,5-diyl, deca-4-ene-4,6-diyl, deca-4-ene-4,7-diyl, deca-4-ene-4,8-diyl, deca-4-ene-4,9-diyl, deca-4-ene-4,10-diyl, deca-4-ene-5,6-diyl, deca-4-ene-5,7-diyl, deca-4-ene-5,8-diyl, deca-4-ene-5,9-diyl, deca-4-ene-5,10-diyl, deca-4-ene-6,7-diyl, deca-4-ene-6,8-diyl, deca-4-ene-6,9-diyl, deca-4-ene-6,10-diyl, deca-4-ene-7,8-diyl, deca-4-ene-7,9-diyl, deca-4-ene-7,10-diyl, deca-4-ene-8,9-diyl, deca-4-ene-8,10-diyl, deca-4-ene-9,10-diyl, deca-5-ene-1,2-diyl, deca-5-ene-1,3-diyl, deca-5-ene-1,4-diyl, deca-5-ene-1,5-diyl, deca-5-ene-1,6-diyl, deca-5-ene-1,7-diyl, deca-5-ene-1,8-diyl, deca-5-ene-1,9-diyl, deca-5-ene-1,10-diyl, deca-5-ene-2,3-diyl, deca-5-ene-2,4-diyl, deca-5-ene-2,5-diyl, deca-5-ene-2,6-diyl, deca-5-ene-2,7-diyl, deca-5-ene-2,8-diyl, deca-5-ene-2,9-diyl, deca-5-ene-2,10-diyl, deca-5-ene-3,4-diyl, deca-5-ene-3,5-diyl, deca-5-ene-3,6-diyl, deca-5-ene-3,7-diyl, deca-5-ene-3,8-diyl, deca-5-ene-3,9-diyl, deca-5-ene-3,10-diyl, deca-5-ene-4,5-diyl, deca-5-ene-4,6-diyl, deca-5-ene-4,7-diyl, deca-5-ene-4,8-diyl, deca-5-ene-4,9-diyl, deca-5-ene-4,10-diyl, deca-5-ene-5,6-diyl, deca-5-ene-5,7-diyl, deca-5-ene-5,8-diyl, deca-5-ene-5,9-diyl, deca-5-ene-5,10-diyl, deca-5-ene-6,7-diyl, deca-5-ene-6,8-diyl, deca-5-ene-6,9-diyl, deca-5-ene-6,10-diyl, deca-5-ene-7,8-diyl, deca-5-ene-7,9-diyl, deca-5-ene-7,10-diyl, deca-5-ene-8,9-diyl, deca-5-ene-8,10-diyl, deca-5-ene-9,10-diyl, prop-1-yne-1,3-diyl, buta-1-yne-1,3-diyl, buta-1-yne-1,4-diyl, buta-1-yne-3,4-diyl, buta-2-yne-1,4-diyl, penta-1-yne-1,3-diyl, penta-1-yne-1,4-diyl, penta-1-yne-1,5-diyl, penta-1-yne-3,4-diyl, penta-1-yne-3,5-diyl, penta-1-yne-4,5-diyl, penta-2-yne-1,4-diyl, penta-2-yne-1,5-diyl, penta-2-yne-4,5-diyl, hexa-1-yne-1,3-diyl, hexa-1-yne-1,4-diyl, hexa-1-yne-1,5-diyl, hexa-1-yne-1,6-diyl, hexa-1-yne-3,4-diyl, hexa-1-yne-3,5-diyl, hexa-1-yne-3,6-diyl, hexa-1-yne-4,5-diyl, hexa-1-yne-4,6-diyl, hexa-1-yne-5,6-diyl, hexa-2-yne-1,4-diyl, hexa-2-yne-1,5-diyl, hexa-2-yne-1,6-diyl, hexa-2-yne-4,5-diyl, hexa-2-yne-4,6-diyl, hexa-2-yne-5,6-diyl, hexa-3-yne-1,2-diyl, hexa-3-yne-1,5-diyl, hexa-3-yne-1,6-diyl, hexa-3-yne-2,5-diyl, hexa-3-yne-2,6-diyl, hexa-3-yne-5,6-diyl, hepta-1-yne-1,3-diyl, hepta-1-yne-1,4-diyl, hepta-1-yne-1,5-diyl, hepta-1-yne-1,6-diyl, hepta-1-yne-1,7-diyl, hepta-1-yne-3,4-diyl, hepta-1-yne-3,5-diyl, hepta-1-yne-3,6-diyl, hepta-1-yne-3,7-diyl, hepta-1-yne-4,5-diyl, hepta-1-in-4,6-diyne, hepta-1-in-4,7-diyne, hepta-1-in-5,6-diyne, hepta-1-in-5,7-diyne, hepta-1-in-6,7-diyne, hepta-2-in-1,4-diyne, hepta-2-in-1,5-diyne, hepta-2-in-1,6-diyne, hepta-2-in-1,7-diyne, hepta-2-in-4,5-diyne, hepta-2-in-4,6-diyne, hepta-2-in-4,7-diyne, hepta-2-in-5,6-diyne, hepta-2-in-5,7-diyne, hepta-2-in-6,7-diyne, hepta-3-in-1,2-diyne, hepta-3-in-1,5-diyne, hepta-3-in-1,6-diyne, hepta-3-in-1,7-diyne, hepta-3-in-2,5-diyne, hepta-3-in-2,6-diyne, hepta-3-in-2,7-diyne, hepta-3-in-5,6-diyne, hepta-3-in-5,7-diyne, hepta-3-in-6,7-diyne, octa-1-in-1,3-diyne, octa-1-in-1,4-diyne, octa-1-in-1,5-diyne, octa-1-in-1,6-diyne, octa-1-in-1,7-diyne, octa-1-in-1,8-diyne, octa-1-in-3,4-diyne, octa-1-in-3,5-diyne, octa-1-in-3,6-diyne, octa-1-in-3,7-diyne, octa-1-in-3,8-diyne, octa-1-in-4,5-diyne, octa-1-in-4,6-diyne, octa-1-in-4,7-diyne, octa-1-in-4,8-diyne, octa-1-in-5,6-diyne, octa-1-in-5,7-diyne, octa-1-in-5,8-diyne, octa-1-in-6,7-diyne, octa-1-in-6,8-diyne, octa-1-in-7,8-diyne, octa-2-in-1,4-diyne, octa-2-in-1,5-diyne, octa-2-in-1,6-diyne, octa-2-in-1,7-diyne, octa-2-in-1,8-diyne, octa-2-in-4,5-diyne, octa-2-in-4,6-diyne, octa-2-in-4,7-diyne, octa-2-in-4,8-diyne, octa-2-in-5,6-diyne, octa-2-in-5,7-diyne, octa-2-in-5,8-diyne, octa-2-in-6,7-diyne, octa-2-in-6,8-diyne, octa-2-in-7,8-diyne, octa-3-in-1,2-diyne, octa-3-in-1,5-diyne, octa-3-in-1,6-diyne, octa-3-in-1,7-diyne, octa-3-in-1,8-diyne, octa-3-in-2,5-diyne, octa-3-in-2,6-diyne, octa-3-in-2,7-diyne, octa-3-in-2,8-diyne, octa-3-in-5,6-diyne, octa-3-in-5,7-diyne, octa-3-in-5,8-diyne, octa-3-in-6,7-diyne, octa-3-in-6,8-diyne, octa-3-in-7,8-diyne, octa-4-in-1,2-diyne, octa-4-in-1,3-diyne, octa-4-in-1,6-diyne, octa-4-in-1,7-diyne, octa-4-in-1,8-diyne, octa-4-in-2,3-diyne, octa-4-in-2,6-diyne, octa-4-in-2,7-diyne, octa-4-in-2,8-diyne, octa-4-in-3,6-diyne, octa-4-in-3,7-diyne, octa-4-in-3,8-diyne, octa-4-in-6,7-diyne, octa-4-in-6,8-diyne, octa-4-in-7,8-diyne, nona-1-in-1,3-diyne, nona-1-in-1,4-diyne, nona-1-in-1,5-diyne, nona-1-in-1,6-diyne, nona-1-in-1,7-diyne, nona-1-in-1,8-diyne, nona-1-in-1,9-diyne, nona-1-in-3,4-diyne, nona-1-in-3,5-diyne, nona-1-in-3,6-diyne, nona-1-in-3,7-diyne, nona-1-in-3,8-diyne, nona-1-in-3,9-diyne, nona-1-in-4,5-diyne, nona-1-in-4,6-diyne, nona-1-in-4,7-diyne, nona-1-in-4,8-diyne, nona-1-in-4,9-diyne, nona-1-in-5,6-diyne, nona-1-in-5,7-diyne, nona-1-in-5,8-diyne, nona-1-in-5,9-diyne, nona-1-in-6,7-diyne, nona-1-in-6,8-diyne, nona-1-in-6,9-diyne, nona-1-in-7,8-diyne, nona-1-in-7,9-diyne, nona-1-in-8,9-diyne, nona-2-in-1,4-diyne, nona-2-in-1,5-diyne, nona-2-in-1,6-diyne, nona-2-in-1,7-diyne, nona-2-in-1,8-diyne, nona-2-in-1,9-diyne, nona-2-in-4,5-diyne, nona-2-in-4,6-diyne, nona-2-in-4,7-diyne, nona-2-in-4,8-diyne, nona-2-in-4,9-diyne, nona-2-in-5,6-diyne, nona-2-in-5,7-diyne, nona-2-in-5,8-diyne, nona-2-in-5,9-diyne, nona-2-in-6,7-diyne, nona-2-in-6,8-diyne, nona-2-in-6,9-diyne, nona-2-in-7,8-diyne, nona-2-in-7,9-diyne, nona-2-in-8,9-diyne, nona-3-in-1,2-diyne, nona-3-in-1,5-diyne, nona-3-in-1,6-diyne, nona-3-in-1,7-diyne, nona-3-in-1,8-diyne, nona-3-in-1,9-diyne, nona-3-in-2,5-diyne, nona-3-in-2,6-diyne, nona-3-in-2,7-diyne, nona-3-in-2,8-diyne, nona-3-in-2,9-diyne, nona-3-in-5,6-diyne, nona-3-in-5,7-diyne, nona-3-in-5,8-diyne, nona-3-in-5,9-diyne, nona-3-in-6,7-diyne, nona-3-in-6,8-diyne, nona-3-in-6,9-diyne, nona-3-in-7,8-diyne, nona-3-in-7,9-diyne, nona-3-in-8,9-diyne, nona-4-in-1,2-diyne, nona-4-in-1,3-diyne, nona-4-in-1,6-diyne, nona-4-in-1,7-diyne, nona-4-in-1,8-diyne, nona-4-in-1,9-diyne, nona-4-in-2,3-diyne, nona-4-in-2,6-diyne, nona-4-in-2,7-diyne, nona-4-in-2,8-diyne, nona-4-in-2,9-diyne, nona-4-in-3,6-diyne, nona-4-in-3,7-diyne, nona-4-in-3,8-diyne, nona-4-in-3,9-diyne, nona-4-in-6,7-diyne, nona-4-in-6,8-diyne, nona-4-in-6,9-diyne, nona-4-in-7,8-diyne, nona-4-in-7,9-diyne, nona-4-in-8,9-diyne, deca-1-in-1,3-diyne, deca-1-in-1,3-diyne, deca-1-in-1,4-diyne, deca-1-in-1,5-diyne, deca-1-in-1,6-diyne, deca-1-in-1,7-diyne, deca-1-in-1,8-diyne, deca-1-in-1,9-diyne, deca-1-in-1,10-diyne, deca-1-in-3,4-diyne, deca-1-in-3,5-diyne, deca-1-in-3,6-diyne, deca-1-in-3,7-diyne, deca-1-in-3,8-diyne, deca-1-in-3,9-diyne, deca-1-in-3,10-diyne, deca-1-in-4,5-diyne, deca-1-in-4,6-diyne, deca-1-in-4,7-diyne, deca-1-in-4,8-diyne, deca-1-in-4,9-diyne, deca-1-in-4,10-diyne, deca-1-in-5,6-diyne, deca-1-in-5,7-diyne, deca-1-in-5,8-diyne, deca-1-in-5,9-diyne, deca-1-in-5,10-diyne, deca-1-in-6,7-diyne, deca-1-in-6,8-diyne, deca-1-in-6,9-diyne, deca-1-in-6,10-diyne, deca-1-in-7,8-diyne, deca-1-in-7,9-diyne, deca-1-in-7,10-diyne, deca-1-in-8,9-diyne, deca-1-in-8,10-diyne, deca-1-in-9,10-diyne, deca-2-in-1,4-diyne, deca-2-in-1,5-diyne, deca-2-in-1,6-diyne, deca-2-in-1,7-diyne, deca-2-in-1,8-diyne, deca-2-in-1,9-diyne, deca-2-in-1,10-diyne, deca-2-in-4,5-diyne, deca-2-in-4,6-diyne, deca-2-in-4,7-diyne, deca-2-in-4,8-diyne, deca-2-in-4,9-diyne, deca-2-in-4,10-diyne, deca-2-in-5,6-diyne, deca-2-in-5,7-diyne, deca-2-in-5,8-diyne, deca-2-in-5,9-diyne, deca-2-in-5,10-diyne, deca-2-in-6,7-diyne, deca-2-in-6,8-diyne, deca-2-in-6,9-diyne, deca-2-in-6,10-diyne, deca-2-in-7,8-diyne, deca-2-in-7,9-diyne, deca-2-in-7,10-diyne, deca-2-in-8,9-diyne, deca-2-in-8,10-diyne, deca-2-in-9,10-diyne, deca-3-in-1,2-diyne, deca-3-in-1,5-diyne, deca-3-in-1,6-diyne, deca-3-in-1,7-diyne, deca-3-in-1,8-diyne, deca-3-in-1,9-diyne, deca-3-in-1,10-diyne, deca-3-in-2,5-diyne, deca-3-in-2,6-diyne, deca-3-in-2,7-diyne, deca-3-in-2,8-diyne, deca-3-in-2,9-diyne, deca-3-in-2,10-diyne, deca-3-in-5,6-diyne, deca-3-in-5,7-diyne, deca-3-in-5,8-diyne, deca-3-in-5,9-diyne, deca-3-in-5,10-diyne, deca-3-in-6,7-diyne, deca-3-in-6,8-diyne, deca-3-in-6,9-diyne, deca-3-in-6,10-diyne, deca-3-in-7,8-diyne, deca-3-in-7,9-diyne, deca-3-in-7,10-diyne, deca-3-in-8,9-diyne, deca-3-in-8,10-diyne, deca-3-in-9,10-diyne, deca-4-in-1,2-diyne, deca-4-in-1,3-diyne, deca-4-in-1,6-diyne, deca-4-in-1,7-diyne, deca-4-in-1,8-diyne, deca-4-in-1,9-diyne, deca-4-in-1,10-diyne, deca-4-in-2,3-diyne, deca-4-in-2,6-diyne, deca-4-in-2,7-diyne, deca-4-in-2,8-diyne, deca-4-in-2,9-diyne, deca-4-in-2,10-diyne, deca-4-in-3,6-diyne, deca-4-in-3,7-diyne, deca-4-in-3,8-diyne, deca-4-in-3,9-diyne, deca-4-in-3,10-diyne, deca-4-in-6,7-diyne, deca-4-in-6,8-diyne, deca-4-in-6,9-diyne, deca-4-in-6,10-diyne, deca-4-in-7,8-diyne, deca-4-in-7,9-diyne, deca-4-in-7,10-diyne, deca-4-in-8,9-diyne, deca-4-in-8,10-diyne, deca-4-in-9,10-diyne, deca-5-in-1,2-diyne, deca-5-in-1,3-diyne, deca-5-in-1,4-diyne, deca-5-in-1,7-diyne, deca-5-in-1,8-diyne, deca-5-in-1,9-diyne, deca-5-in-1,10-diyne, deca-5-in-2,3-diyne, deca-5-in-2,4-diyne, deca-5-in-2,7-diyne, deca-5-in-2,8-diyne, deca-5-in-2,9-diyne, deca-5-in-2,10-diyne, deca-5-in-3,4-diyne, deca-5-in-3,7-diyne, deca-5-in-3,8-diyne, deca-5-in-3,9-diyne, deca-5-in-3,10-diyne, deca-5-in-4,7-diyne, deca-5-in-4,8-diyne, deca-5-in-4,9-diyne, deca-5-in-4,10-diyne, deca-5-in-7,8-diyne, deca-5-in-7,9-diyne, deca-5-in-7,10-diyne, deca-5-in-8,9-diyne, deca-5-in-8,10-diyne, deca-5-in-9,10-diyne, and the like, and the divalent hydrocarbon group which may have an unsaturated bond has preferably 2 to 6 carbon atoms, and more preferably 2 to 4 carbon atoms.

From the viewpoint of raw material availability, in the monovalent alicyclic hydrocarbon group of A represented by formula (4a), formula (4b), formula (4c), or formula (4d), it is more preferable that R⁵ in formula (4a) or formula (4c) is hydrogen, L is 1,2-ethanediyl, m is 0, R⁵ in formula (4b) or formula (4d) is hydrogen, R⁶ is carbonyl, R⁷ is nitrogen, and L is 1,3-propanediyl.

The organopolysiloxane compound of the disclosure is synthesized by a process of reacting an organometallic compound with a cyclic siloxane to generate a metal silanolate, followed by a process of reacting cyclotrisiloxane or cyclotetrasiloxane with the metal silanolate to generate a compound represented by formula (5), a process of generating a compound represented by formula (5′) by stopping polymerization by adding water or acid to the compound represented by formula (5) as needed, and further followed by a process of reacting a compound represented by formula (6) (a chlorosilane compound having a cycloolefin skeleton) with the compound represented by formula (5) or formula (5′).

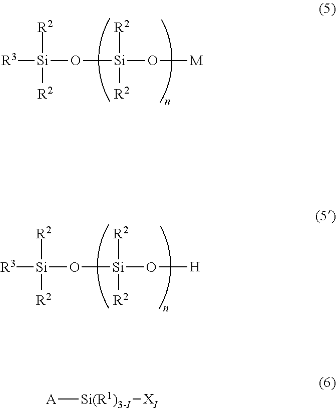

In formula (5) and formula (5′), R² is alkyl having 1 to 10 carbon atoms or aryl having 6 to 10 carbon atoms, R³ is alkyl having 4 to 10 carbon atoms, n is an integer of 1 or more, and multiple R² may be the same or different. Further, M in formula (5) is a monovalent metal. In formula (6), A is a monovalent alicyclic hydrocarbon group having 4 to 60 carbon atoms and having at least one carbon-carbon double bond, R¹ is alkyl having 1 to 10 carbon atoms or aryl having 6 to 10 carbon atoms, X is halogen, and I is an integer of 1 to 3.

Specific examples of the organometallic compound when synthesizing the organopolysiloxane compound include methyllithium, ethyllithium, propyllithium, n-butyllithium, s-butyllithium, t-butyllithium, phenyllithium, or phenylsodium. Among these, methyllithium, n-butyllithium, s-butyllithium, t-butyllithium, or phenyllithium is preferable, and n-butyllithium is particularly preferable.

Specific examples of the cyclic siloxane when synthesizing the organopolysiloxane compound include trimethylcyclotrisiloxane, hexamethylcyclotrisiloxane, hexaethylcyclotrisiloxane, pentamethylvinylcyclotrisiloxane, trimethyltrivinylcyclotrisiloxane, trimethyltriphenylcyclotrisiloxane, hexaphenylcyclotrisiloxane, tris(trifluoropropyl)trimethylcyclotrisiloxane, tetramethylcyclotetrasiloxane, octamethylcyclotetrasiloxane, heptamethylcyclotetrasiloxane, tetramethyltetravinylcyclotetrasiloxane, tetramethyltetraphenylcyclotetrasiloxane, octaphenylcyclotetrasiloxane, or tetrakis(trifluoropropyl)tetramethylcyclotetrasiloxane. Among these, trimethylcyclotrisiloxane and tetramethylcyclotetrasiloxane are preferable.

As the reaction solvent when synthesizing the organopolysiloxane compound, a nonpolar or low-polarity aprotic solvent is used. Specific examples of nonpolar aprotic solvents include hexane, cyclohexane, heptane, toluene, and xylene. Specific examples of low-polarity aprotic solvents include diethyl ether, dipropyl ether, diisopropyl ether, dibutyl ether, diethylene glycol dimethyl ether, triethylene glycol dimethyl ether, tetrahydrofuran (THF), 4-methyltetrahydropyran, cyclopentyl methyl ether (CPME), 1,4-dioxane, and the like. Among these, it is preferable to use a nonpolar solvent to facilitate control of reaction activity, and it is particularly preferable to use toluene in consideration of the solubility of the product.

In the case of using a nonpolar solvent as the reaction solvent when synthesizing the organopolysiloxane compound, a high-polarity aprotic solvent may be added as a reaction agent for the purpose of promoting the progress of the polymerization reaction. Specific examples of high-polarity aprotic solvents include N,N-dimethylformamide (DMF), N,N-diethylformamide (DEF), dimethoxyethane, dimethyl sulfoxide (DMSO), N-methyl-2-pyrrolidone (NMP), and the like. Among these, it is preferable to use N,N-dimethylformamide (DMF) in consideration of the ease of removal by washing with water.

Specific examples of cyclotrisiloxane or cyclotetrasiloxane to be reacted with the generated metal silanolate include trimethylcyclotrisiloxane, hexamethylcyclotrisiloxane, pentamethylvinylcyclotrisiloxane, hexaethylcyclotrisiloxane, trimethyltrivinylcyclotrisiloxane, trimethyltriphenylcyclotrisiloxane, hexaphenylcyclotrisiloxane, tris(trifluoropropyl)trimethylcyclotrisiloxane, tetramethylcyclotetrasiloxane, heptamethylcyclotetrasiloxane, octamethylcyclotetrasiloxane, tetramethyltetravinylcyclotetrasiloxane, tetramethyltetraphenylcyclotetrasiloxane, octaphenylcyclotetrasiloxane, or tetrakis(trifluoropropyl)tetramethylcyclotetrasiloxane. Among these, trimethylcyclotrisiloxane, hexamethylcyclotrisiloxane, trimethyltriphenylcyclotrisiloxane, hexaphenylcyclotrisiloxane, tris(trifluoropropyl)trimethylcyclotrisiloxane, tetramethylcyclotetrasiloxane, octamethylcyclotetrasiloxane, tetramethyltetraphenylcyclotetrasiloxane, octaphenylcyclotetrasiloxane, or tetrakis(trifluoropropyl)tetramethylcyclotetrasiloxane is preferable, and hexamethylcyclotrisiloxane or octamethylcyclotetrasiloxane is particularly preferable.

In the compound represented by formula (5), M is not particularly limited as long as M is a monovalent metal, but specific examples include lithium or sodium, and among these, lithium is preferable.

The polymerization is stopped by adding water or acid to the compound represented by formula (5) as needed. In the case of using acid for this purpose, the acid used is not particularly limited as long as the acid is Brønsted acid or an aqueous solution thereof, but specific examples of the type of acid include formic acid, acetic acid, nitric acid, sulfuric acid, and hydrochloric acid, and among these, acetic acid is preferable.

In the compound represented by formula (6), the halogen of X is particularly preferably chlorine.

In the process of reacting the compound represented by formula (6) with the compound represented by formula (5) or formula (5′), it is preferable to add an organic base for the purpose of capturing hydrochloric acid (HCl) generated by the reaction between chlorosilane and water or silanol. Specific examples of the organic base used include trimethylamine, pyridine, diisopropylethylamine, N,N-dimethylaniline, N,N-dimethylbenzylamine, 1,8-diazabicyclo[5.4.0]undec-7-ene (DBU), 1,5-diazabicyclo[4.3.0]non-5-ene (DBN), and the like, but considering the boiling point and basicity strength, it is preferable to use triethylamine.

For the compound represented by formula (6), a commercially available product can be used, but the compound represented by formula (6) may also be synthesized and used by hydrosilylation reaction between the compound represented by formula (7) and the compound represented by formula (8).

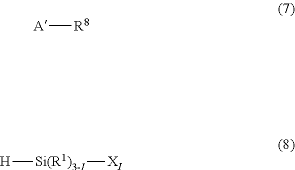

In formula (7), A′ is a monovalent alicyclic hydrocarbon group having 4 to 58 carbon atoms and having at least one carbon-carbon double bond, and R⁸ is a hydrocarbon group having at least one unsaturated bond at the terminal. In formula (8), R¹ is alkyl having 1 to 10 carbon atoms or aryl having 6 to 10 carbon atoms, X is halogen, and I is an integer of 1 to 3.

The monovalent alicyclic hydrocarbon group having 4 to 58 carbon atoms and having a carbon-carbon double bond in A′ is, for example, cyclobutenyl, cyclopentenyl, cyclopentadienyl, cyclohexenyl, cyclohexadienyl, cycloheptenyl, cyclooctenyl, cyclononenyl, cyclodecenyl, cyclododecenyl, cyclotetradecenyl, cyclohexadecenyl, cyclooctadecenyl, cycloeicoenyl, cyclodocoenyl, cyclotetracoenyl, cyclohexacoenyl, cyclooctacoenyl, norbornenyl, norbornadienyl, dicyclopentenyl, dicyclopentadienyl, dicyclohexenyl, dicyclohexadienyl, tricyclodecenyl, tetracyclododecenyl, tetracyclododecadienyl, and the like, and at least one hydrogen of these groups may be substituted with alkyl, halogen, heteroatom, haloalkyl, or heteroatom-substituted alkyl. The monovalent alicyclic hydrocarbon group having a carbon-carbon double bond has preferably 4 to 30 carbon atoms, and more preferably 5 to 15 carbon atoms.

The hydrocarbon group having at least one unsaturated bond at the terminal in R⁸ is, for example, vinyl, allyl, 1-butenyl, 1-pentenyl, 1-hexenyl, 1-heptenyl, 1-octenyl, 1-nonenyl, 1-decenyl, isopropenyl, isobutenyl, butadienyl, and the like, and the hydrocarbon group having at least one unsaturated bond at the terminal has preferably 2 to 20 carbon atoms, and more preferably 2 to 10 carbon atoms.

In the case of synthesizing the compound represented by formula (6) by hydrosilylation reaction, a hydrosilylation reaction catalyst is used. As the hydrosilylation reaction catalyst, a platinum-based catalyst, a rhodium-based catalyst, and a palladium-based catalyst are generally used. Among these, it is preferable to use Speier catalyst or Karstedt catalyst, which are platinum-based catalysts, from the viewpoint of reactivity and solubility in the reaction system.

The compound represented by formula (1) can be composited with a cycloolefin monomer by ring opening metathesis polymerization (ROMP) or addition polymerization. The compound represented by formula (1) can be added to a ROMP reaction system of a cycloolefin monomer or an addition polymerization reaction system with an olefin monomer or a cycloolefin monomer, and copolymerized for the purpose of imparting organopolysiloxane-derived functions. Examples of methods of addition polymerization include coordination polymerization and cationic polymerization.

The cycloolefin monomer that can be used for ROMP with the compound represented by formula (1) is not particularly limited, but specific examples include 2-norbornene, 5-ethylidene-2-norbornene, 5-norbornene-2-carboxylic acid, 5-norbornene-2-carbonitrile, 5-norbornene-2-methylamine, 5-norbornene-2-methanol, 3a,4,7,7a-tetrahydroindene, tetracyclododecadiene, 1,4-dihydro-1,4-methanonaphthalene, 5-norbornene-2,3-dicarboximide, dicyclopentadiene, 2,5-norbornadiene, 5-norbornene-2,3-dicarboxylic anhydride, tetracyclo[6.2.1.1^{3,6}.0^{2,7}]dodeca-4-ene, 5,6-dihydrocyclopentadiene, cyclobutene, cyclopentene, cyclohexene, cycloheptene, cyclooctene, cyclononene, cyclodecene, cyclobutadiene, cyclopentadiene, cyclohexadiene, cycloheptadiene, cyclooctadiene, cyclononadiene, cyclodecadiene, and the like.

In the case of obtaining a copolymer of the compound represented by formula (1) and a cycloolefin monomer by ROMP, a metathesis polymerization catalyst is used. Hereinafter, the cycloolefin polymer synthesized using ROMP may be described as ROMP polymer.

The metathesis polymerization catalyst used for ROMP is not particularly limited, but specific examples include Grubbs first generation catalyst, Grubbs second generation catalyst, Hoveyda-type Grubbs catalyst, Grubbs third generation catalyst, and the like.

As described in Japanese Patent No. 5613981, in ROMP, a molecular weight modifier may be added to the reaction system for the purpose of adjusting the molecular weight of the obtained polymer.

The molecular weight modifier to be used is not particularly limited, but specific examples include α-olefins such as 1-butene, 1-pentene, 1-hexene, and 1-octene, and styrenes such as styrene and vinyltoluene; ethers such as ethyl vinyl ether, isobutyl vinyl ether, and allyl glycidyl ether, halogen-containing vinyl compounds such as allyl chloride; oxygen-containing vinyl compounds such as glycidyl methacrylate; nitrogen-containing vinyl compounds such as acrylamide; non-conjugated dienes such as 1,4-pentadiene, 1,4-hexadiene, 1,5-hexadiene, 1,6-heptadiene, 2-methyl-1,4-pentadiene, and 2,5-dimethyl-1,5-hexadiene, or conjugated dienes such as 1,3-butadiene, 2-methyl-1,3-butadiene, 2,3-dimethyl-1,3-butadiene, 1,3-pentadiene, and 1,3-hexadiene.

The cycloolefin monomer that can be used for ROMP with the compound represented by formula (1) may be one type or two or more types. The cycloolefin polymer is widely used for optical components, packaging materials for pharmaceuticals and foods, substrates for electronic devices, and the like, and can be used in appropriate combinations according to the applications.

The ratio of the compound represented by formula (1) and the cycloolefin monomer used as raw materials for the polymer (cycloolefin polymer) of the disclosure is not particularly limited and can be adjusted, but effects of water repellency and sliding properties can be imparted even at a ratio of about 0.1% by weight to 10% by weight, with the total amount of the compound represented by formula (1) and the cycloolefin monomer being 100.

The polymer of the disclosure can be processed into a film or a molded article by commonly used methods. As a film formation method, there is a method of dissolving the polymer in a solvent, applying a solution thereof, and then drying the solution to obtain a free-standing film. As a molded article manufacturing method, there is an injection molding method.

The solvent that can be used in dissolving the polymer of the disclosure is not particularly limited, but specific examples include cyclic ether solvents such as cyclopentyl methyl ether (CPME), tetrahydrofuran (THF), and 4-methyltetrahydropyran (MTHP), halogenated hydrocarbon solvents such as chloroform, dichloromethane, and dichlorobenzene, glycol ether solvents such as propyleneglycol-1-monomethylether-2-acetate (PGMEA) and propyleneglycol-1-monomethylether (PGME), and the like. It is preferable to use CPME from the viewpoint of solubility and drying speed during film formation.

In the coordination polymerization of the compound represented by formula (1), acyclic olefin monomers represented by monoolefins such as ethene, propene, 1-butene, 1-pentene, 1-hexene, isobutene, 2-methyl-1-butene, and 2-methyl-1-pentene, diolefins such as 1,3-butadiene, 2-methyl-1,3-butadiene, and 1,3-pentadiene, and aromatic olefin monomers including styrene, 2-phenyl-1-propene, and vinylnaphthalene, and cycloolefin monomers including 2-norbornene, 5-ethylidene-2-norbornene, 5-norbornene-2-carboxylic acid, 5-norbornene-2-carbonitrile, 5-norbornene-2-methylamine, 5-norbornene-2-methanol, 3a,4,7,7a-tetrahydroindene, tetracyclododecadiene, 1,4-dihydro-1,4-methanonaphthalene, 5-norbornene-2,3-dicarboximide, dicyclopentadiene, 2,5-norbornadiene, 5-norbornene-2,3-dicarboxylic anhydride, tetracyclo[6.2.1.1^{3,6}.0^{2,7}]dodeca-4-ene, 5,6-dihydrocyclopentadiene, cyclobutene, cyclopentene, cyclohexene, cycloheptene, cyclooctene, cyclononene, cyclodecene, cyclobutadiene, cyclopentadiene, cyclohexadiene, cycloheptadiene, cyclooctadiene, cyclononadiene, and cyclodecadiene can be used as monomers for copolymerization.

In the coordination polymerization of the compound represented by formula (1), a catalyst including transition metal compounds such as titanium (Ti), zirconium (Zr), chromium (Cr), cobalt (Co), nickel (Ni), palladium (Pd), and zinc (Zn) is used as the coordination polymerization catalyst.

In the cationic polymerization of the compound represented by formula (1), acyclic olefin monomers represented by monoolefins such as ethene, propene, 1-butene, 1-pentene, 1-hexene, isobutene, 2-methyl-1-butene, and 2-methyl-1-pentene, diolefins such as 1,3-butadiene, 2-methyl-1,3-butadiene, and 1,3-pentadiene, and aromatic olefin monomers including styrene, 2-phenyl-1-propene, and vinylnaphthalene, cyclic ether monomers including ethylene oxide, propylene oxide, trimethylene oxide, 1,4-dioxane, 1,3,5-trioxane, cyclohexane oxide, styrene oxide, epichlorohydrin, glycidyl phenyl ether, furan, and tetrahydrofuran, and cycloolefin monomers including 2-norbornene, 5-ethylidene-2-norbornene, 5-norbornene-2-carboxylic acid, 5-norbornene-2-carbonitrile, 5-norbornene-2-methylamine, 5-norbornene-2-methanol, 3a,4,7,7a-tetrahydroindene, tetracyclododecadiene, 1,4-dihydro-1,4-methanonaphthalene, 5-norbornene-2,3-dicarboximide, dicyclopentadiene, 2,5-norbornadiene, 5-norbornene-2,3-dicarboxylic anhydride, tetracyclo[6.2.1.1^{3,6}.0^{2,7}]dodeca-4-ene, 5,6-dihydrocyclopentadiene, cyclobutene, cyclopentene, cyclohexene, cycloheptene, cyclooctene, cyclononene, cyclodecene, cyclobutadiene, cyclopentadiene, cyclohexadiene, cycloheptadiene, cyclooctadiene, cyclononadiene, and cyclodecadiene can be used as monomers for copolymerization.

In the cationic polymerization of the compound represented by formula (1), commonly used catalysts for cationic polymerization may be used, and metal halides such as AlCl₃, AlBr₃, BCl₃, BF₃, TiCl₄, TiBr₄, FeCl₃, FeCl₂, SnCl₂, and SnCl₄, protonic acids such as HCl, HF, and HBr, and oxoacids such as H₂SO₄, H₃BO₃, HClO₄, and CH₃COOH₃ can be used.

### EXAMPLES

Hereinafter, the disclosure will be described in more detail with reference to examples. Nevertheless, the disclosure is not limited to these examples in any way.

### <Measurement of Molecular Weight>

The molecular weight of the organopolysiloxane compound was measured by gel permeation chromatography (GPC), and the ratio of weight average molecular weight (Mw) to number average molecular weight (Mn) was defined as molecular weight distribution (Mw/Mn).

Polydimethylsiloxane was used as a standard sample, and the polydimethylsiloxane-equivalent molecular weight was measured.

The polystyrene-equivalent molecular weight measurement by GPC was performed under the following measurement conditions.
a) Measurement instrument: HPLC LC-2000Plus series manufactured by JASCO Corporation
b) Column: Shodex KF-804L manufactured by Resonac Corporation (formerly Showa Denko K.K.) (two columns connected in series)
c) Oven temperature: 40° C.
d) Eluent: toluene 0.7 mL/min
e) Detector: RI-2031
f) Standard sample: polydimethylsiloxane
g) Injection volume: 20 μL
h) Concentration: 0.025 g/10 mL
i) Sample preparation: Dissolved at room temperature using toluene as a solvent.

The molecular weight of the polymer obtained by ROMP was measured by gel permeation chromatography (GPC), and the ratio of weight average molecular weight (Mw) to number average molecular weight (Mn) was defined as molecular weight distribution (Mw/Mn). Polystyrene was used as a standard sample, and the polystyrene-equivalent molecular weight was measured.

The polystyrene-equivalent molecular weight measurement by GPC was performed under the following measurement conditions.
a) Measurement instrument: HPLC LC-2000Plus series manufactured by JASCO Corporation
b) Column: Shodex KF-805L manufactured by Resonac Corporation (formerly Showa Denko K.K.) and Shodex KF-804L manufactured by Resonac Corporation (formerly Showa Denko K.K.) (two columns connected in series)
c) Oven temperature: 40° C.
d) Eluent: THF 1.0 mL/min
e) Detector: RI-2031
f) Standard sample: polystyrene
g) Injection volume: 20 μL
h) Concentration: 0.025 g/10 mL
i) Sample preparation: Dissolved at room temperature using THE as a solvent.

### <Analysis of Compound>

### <NMR (Nuclear Magnetic Resonance Spectrum)>

Using a 500 MHz NMR measurement apparatus manufactured by JEOL Ltd., ¹H-NMR and ²⁹Si-NMR were measured at room temperature by dissolving the measurement sample in deuterated chloroform (manufactured by FUJIFILM Wako Pure Chemical Corporation).

### Example 1

### Synthesis of Organopolysiloxane Compound (1-1) where x=1 in Formula (2)

To a 100 mL four-neck flask equipped with a reflux condenser, a thermometer, and a septum cap, 10.07 g of hexamethylcyclotrisiloxane and 14 mL of toluene were introduced and sealed with nitrogen. The flask was set in an oil bath maintained at 30° C. and heated. Then, when the liquid temperature reached 30° C., 3.0 mL of n-butyllithium (1.6 M hexane solution) was introduced, and 1.25 mL of DMF was added to initiate polymerization. After reacting for 2 hours and 30 minutes, 0.46 g of triethylamine and 0.97 g of 5-norbornene-2-yl(ethyl) chlorodimethylsilane were introduced. After reacting for 18 hours, the reaction was terminated by introducing 50 mL of distilled water and 50 mL of heptane. After completion of the reaction, the reaction mixture was introduced into a separatory funnel. The mixture was separated into an aqueous layer and an organic layer in the separatory funnel, and the aqueous layer was discarded. Next, 50 mL of 1N hydrochloric acid was added to wash the organic layer. After washing, the mixture was separated into an aqueous layer and an organic layer in the separatory funnel, and the aqueous layer was discarded. Next, 50 mL of saturated sodium bicarbonate aqueous solution was added to wash the organic layer. After washing, the mixture was separated into an aqueous layer and an organic layer in the separatory funnel, and the aqueous layer was discarded. Next, 50 mL of distilled water was added to wash the organic layer. After washing, the mixture was separated into an aqueous layer and an organic layer in the separatory funnel, and the aqueous layer was discarded. The organic layer was dried with anhydrous sodium sulfate, filtered, and transferred to a rotary evaporator, and the solvent was distilled off at 55° C. under 1 kPa. The obtained oil (9.01 g) had GPC data: Mn=2540, Mw=2820, and Mw/Mn=1.11.

The chemical shifts obtained by ¹H-NMR and ²⁹Si-NMR measurements of the final product are shown below.

¹H-NMR: δ (ppm); 6.20 to 6.01 (2H), 2.89 to 2.85 (2H), 1.46 to 1.38 (12H), 1.05 to 0.98 (6H), 0.67 to 0.63 (4H), 0.30 to −0.07 (166H).

²⁹Si-NMR: δ (ppm); 8.95, −5.55, −18.51, −20.33 to −20.81.

These NMR measurement results confirmed that the obtained compound had the structure of formula (1-1). In formula (1-1), Me is methyl, and n is 27 on average.

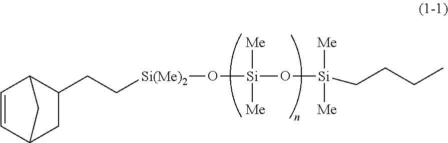

### Example 2

### Synthesis of Organopolysiloxane Compound (1-2) where x=2 in Formula (2)

To a 100 mL four-neck flask equipped with a reflux condenser, a thermometer, and a septum cap, 10.07 g of hexamethylcyclotrisiloxane and 14 mL of toluene were introduced and sealed with nitrogen. The flask was set in an oil bath maintained at 30° C. and heated. Then, when the liquid temperature reached 30° C., 3.0 mL of n-butyllithium (1.6 M hexane solution) was introduced, and 1.25 mL of DMF was added to initiate polymerization. After reacting for 2 hours and 30 minutes, 0.46 g of triethylamine and 0.53 g of 5-norbornene-2-yl(ethyl)dichloromethylsilane were introduced. After reacting for 18 hours, the reaction was terminated by introducing 50 mL of distilled water and 50 mL of heptane. After completion of the reaction, the reaction mixture was introduced into a separatory funnel. The mixture was separated into an aqueous layer and an organic layer in the separatory funnel, and the aqueous layer was discarded. Next, 50 mL of 1N hydrochloric acid was added to wash the organic layer. After washing, the mixture was separated into an aqueous layer and an organic layer in the separatory funnel, and the aqueous layer was discarded. Next, 50 mL of saturated sodium bicarbonate aqueous solution was added to wash the organic layer. After washing, the mixture was separated into an aqueous layer and an organic layer in the separatory funnel, and the aqueous layer was discarded. Next, 50 mL of distilled water was added to wash the organic layer. After washing, the mixture was separated into an aqueous layer and an organic layer in the separatory funnel, and the aqueous layer was discarded. The organic layer was dried with anhydrous sodium sulfate, filtered, and transferred to a rotary evaporator, and the solvent was distilled off at 55° C. under 1 kPa. The obtained oil (9.37 g) had GPC data: Mn=4340, Mw=4620, and Mw/Mn=1.06.

The chemical shifts obtained by ¹H-NMR and ²⁹Si-NMR measurements of the final product are shown below.

¹H-NMR: δ (ppm); 6.20 to 6.01 (2H), 2.89 to 2.85 (2H), 1.46 to 1.38 (20H), 1.05 to 0.98 (12H), 0.67 to 0.63 (8H), 0.25 to −0.05 (332H).

²⁹Si-NMR: δ (ppm); 9.14, 8.82, −19.02, −19.80 to −20.91, −36.06.

These NMR measurement results confirmed that the obtained compound had the structure of formula (1-2). In formula (1-2), Me is methyl, and n is 28 on average.

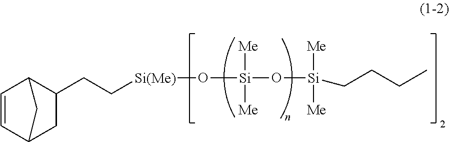

### Example 3

### Synthesis of Organopolysiloxane Compound (1-3) where x=3 in Formula (2)

To a 100 mL four-neck flask equipped with a reflux condenser, a thermometer, and a septum cap, 10.07 g of hexamethylcyclotrisiloxane and 14 mL of toluene were introduced and sealed with nitrogen. The flask was set in an oil bath maintained at 30° C. and heated. Then, when the liquid temperature reached 30° C., 3.0 mL of n-butyllithium (1.6 M hexane solution) was introduced, and 1.25 mL of DMF was added to initiate polymerization. After reacting for 2 hours and 30 minutes, 0.46 g of triethylamine and 0.40 g of 5-norbornene-2-yl(ethyl)trichlorosilane were introduced. After reacting for 18 hours, the reaction was terminated by introducing 50 mL of distilled water and 50 mL of heptane. After completion of the reaction, the reaction mixture was introduced into a separatory funnel. The mixture was separated into an aqueous layer and an organic layer in the separatory funnel, and the aqueous layer was discarded. Next, 50 mL of 1N hydrochloric acid was added to wash the organic layer. After washing, the mixture was separated into an aqueous layer and an organic layer in the separatory funnel, and the aqueous layer was discarded. Next, 50 mL of saturated sodium bicarbonate aqueous solution was added to wash the organic layer. After washing, the mixture was separated into an aqueous layer and an organic layer in the separatory funnel, and the aqueous layer was discarded. Next, 50 mL of distilled water was added to wash the organic layer. After washing, the mixture was separated into an aqueous layer and an organic layer in the separatory funnel, and the aqueous layer was discarded. The organic layer was dried with anhydrous sodium sulfate, filtered, and transferred to a rotary evaporator, and the solvent was distilled off at 55° C. under 1 kPa. The obtained oil (9.22 g) had GPC data: Mn=5230, Mw=5980, and Mw/Mn=1.14.

The chemical shifts obtained by ¹H-NMR and ²⁹Si-NMR measurements of the final product are shown below.

¹H-NMR: δ (ppm); 6.20 to 6.01 (2H), 2.89 to 2.85 (2H), 1.46 to 1.38 (28H), 1.05 to 0.98 (18H), 0.67 to 0.63 (12H), 0.25 to −0.05 (549H).

²⁹Si-NMR: δ (ppm); 9.12, −8.59, −19.02, −20.18 to −20.60, −61.04.

These NMR measurement results confirmed that the obtained compound had the structure of formula (1-3). In formula (1-3), Me is methyl, and n is 30 on average.

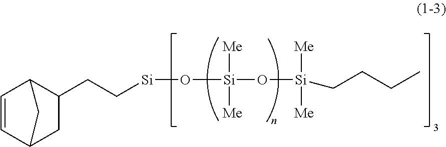

### Example 4

### Synthesis of ROMP Polymer Obtained by Reacting Compound (1-1) with Dicyclopentadiene

In a glove box, dicyclopentadiene (1.0 g), dehydrated cyclohexene 19.2 g, compound (1-1) 10.2 mg, and 1-hexene 4.5 mg were added to a screw-cap PFA container equipped with a magnetic stirrer. Next, Grubbs second generation catalyst 64.2 mg was added to initiate polymerization, and the mixture was stirred at room temperature for 2 hours. After adding ethyl vinyl ether to the reaction solution, the reaction solution was dropped into 200 mL of methanol to obtain a precipitate. After removing the supernatant by decantation, the precipitate was dissolved in THF, and this solution was dropped into 200 mL of methanol to obtain a precipitate. The operations of removing the supernatant, dissolving in THF, and obtaining the precipitate were repeated two more times, and 0.92 g of a polymer of compound (1-1) and dicyclopentadiene was recovered.

As a result of GPC analysis of the obtained polymer, the number average molecular weight (Mn) was 27,000, the weight average molecular weight (Mw) was 48,000, and the molecular weight distribution (Mw/Mn) was 1.78.

### Example 5

### Synthesis of ROMP Polymer Obtained by Reacting Compound (1-2) with Dicyclopentadiene

In a glove box, dicyclopentadiene (1.0 g), dehydrated cyclohexene 19.2 g, compound (1-2) 10.7 mg, and 1-hexene 5.2 mg were added to a screw-cap PFA container equipped with a magnetic stirrer. Next, Grubbs second generation catalyst 57.6 mg was added to initiate polymerization, and the mixture was stirred at room temperature for 2 hours. After adding ethyl vinyl ether to the reaction solution, the reaction solution was dropped into 200 mL of methanol to obtain a precipitate. After removing the supernatant by decantation, the precipitate was dissolved in THF, and this solution was dropped into 200 mL of methanol to obtain a precipitate. The operations of removing the supernatant, dissolving in THE, and obtaining the precipitate were repeated two more times, and 1.04 g of a polymer of compound (1-2) and dicyclopentadiene was recovered.

As a result of GPC analysis of the obtained polymer, the number average molecular weight (Mn) was 26,000, the weight average molecular weight (Mw) was 41,000, and the molecular weight distribution (Mw/Mn) was 1.58.

### Example 6

### Synthesis of ROMP Polymer Obtained by Reacting Compound (1-3) with Dicyclopentadiene

In a glove box, dicyclopentadiene (1.0 g), dehydrated cyclohexene 19.2 g, compound (1-3) 9.8 mg, and 1-hexene 6.7 mg were added to a screw-cap PFA container equipped with a magnetic stirrer. Next, Grubbs second generation catalyst 62.3 mg was added to initiate polymerization, and the mixture was stirred at room temperature for 2 hours. After adding ethyl vinyl ether to the reaction solution, the reaction solution was dropped into 200 mL of methanol to obtain a precipitate. After removing the supernatant by decantation, the precipitate was dissolved in THE, and this solution was dropped into 200 mL of methanol to obtain a precipitate. The operations of removing the supernatant, dissolving in THE, and obtaining the precipitate were repeated two more times, and 0.95 g of a polymer of compound (1-3) and dicyclopentadiene was recovered.

As a result of GPC analysis of the obtained polymer, the number average molecular weight (Mn) was 15,000, the weight average molecular weight (Mw) was 32,000, and the molecular weight distribution (Mw/Mn) was 2.13.

### Comparative Example 1

### Synthesis of ROMP Polymer Using Dicyclopentadiene Alone

In a glove box, dicyclopentadiene (1.0 g), dehydrated cyclohexene 19.2 g, and 1-hexene 4.3 mg were added to a screw-cap PFA container equipped with a magnetic stirrer. Next, Grubbs second generation catalyst 61.5 mg was added to initiate polymerization, and the mixture was stirred at room temperature for 2 hours. After adding ethyl vinyl ether to the reaction solution, the reaction solution was dropped into 200 mL of methanol to obtain a precipitate. After removing the supernatant by decantation, the precipitate was dissolved in THE, and this solution was dropped into 200 mL of methanol to obtain a precipitate. The operations of removing the supernatant, dissolving in THE, and obtaining the precipitate were repeated two more times, and 1.09 g of a polymer using dicyclopentadiene alone was recovered.

As a result of GPC analysis of the obtained polymer, the number average molecular weight (Mn) was 12,000, the weight average molecular weight (Mw) was 23,000, and the molecular weight distribution (Mw/Mn) was 1.92.

### <Contact Angle Measurement>

Contact angle measurement was performed on the polymers obtained in Example 4 to Example 6 and the polymer using dicyclopentadiene alone obtained in Comparative Example 1. Cast films obtained by dropping a solution of each polymer dissolved in cyclopentyl methyl ether (CPME) onto a glass substrate and drying were used as samples for contact angle measurement. Purified water was used as the probe liquid for contact angle measurement. After forming a 1.5 μL droplet of purified water at the tip of a syringe needle, the syringe needle was moved toward the sample side to deposit the droplet on the sample surface. A still image of the droplet deposited on the sample surface was captured, and based on the captured still image, the contact angle was determined by the θ/2 method assuming the contour shape of the droplet to be a perfect circle. Measurement was performed 10 times on the same sample, and the average value was taken as the contact angle. The contact angle values were recorded as ⊚ for 90° or more, ◯ for 60° or more and less than 90°, and × for less than 60°.

### <Results of Contact Angle Measurement>

Table 1 shows the results of contact angle measurement of the polymers obtained in Example 4 to Example 6 and the polymer using dicyclopentadiene alone obtained in Comparative Example 1. The contact angle value of the polymer of Example 4 was 88.1°. The contact angle value of the polymer of Example 5 was 84.7°. The contact angle value of the polymer of Example 6 was 97.2°. The contact angle value of the polymer of Comparative Example 1 was 50.6°.

TABLE 1

| | Results of Contact |
|---|---|
| | Angle Measurement |
| Example 4 | ◯ (88.1°) |
| Example 5 | ◯ (84.7°) |
| Example 6 | ⊚ (97.2°) |
| Comparative | X (50.6°) |
| Example 1 | |

The results of contact angle measurement shown in Table 1 demonstrated that the water repellency of cycloolefin polymer can be improved by copolymerizing the organopolysiloxane compound obtained in the disclosure with the cycloolefin monomer. In particular, the polymer of Example 6, in which the organopolysiloxane compound (1-3) obtained in Example 3 was copolymerized with the cycloolefin monomer, showed excellent water repellency improvement capability, demonstrating that increasing the number of introduced polysiloxane chains resulted in greater improvement in water repellency.

### <Water Sliding Property Evaluation>

Water sliding property evaluation was performed on the polymers obtained in Example 4 to Example 6 and the polymer using dicyclopentadiene alone obtained in Comparative Example 1. Cast films prepared in the same manner as for contact angle measurement were used as evaluation samples. DropMaster 500 (manufactured by Kyowa Interface Science Co., Ltd.) was used for evaluation. Purified water was used as the probe liquid. After forming a 5 μL water droplet at the tip of a syringe needle, the water droplet was deposited on the sample surface by moving the syringe needle side. This operation was repeated 3 times to deposit a total of 15 μL water droplet, then the sample stage was tilted at a tilting speed of 2 degrees/second, and in the case where it was confirmed that the contact point on the receding side of the water droplet moved 1 mm, it was determined as “having sliding properties”. In the case where the contact point on the advancing side of the water droplet could not move 1 mm when the tilting angle reached 90 degrees, it was determined as “having no sliding properties”. The case with sliding properties was marked as ◯, and the case without sliding properties was marked as ×.

### <Results of Water Sliding Property Evaluation>

Table 2 shows the results of sliding property evaluation of the polymers obtained in Example 4 to Example 6 and the polymer using dicyclopentadiene alone obtained in Comparative Example 1. The polymers obtained in Example 4 to Example 6 had sliding properties, whereas the polymer using dicyclopentadiene alone obtained in Comparative Example 1 had no sliding properties.

TABLE 2

| | Results of Sliding |
|---|---|
| | Property Evaluation |
| Example 4 | ◯ |
| Example 5 | ◯ |
| Example 6 | ◯ |
| Comparative | X |
| Example 1 | |

The results of water sliding property evaluation shown in Table 2 demonstrated that sliding properties can be imparted to a cycloolefin polymer by copolymerizing the organopolysiloxane compound obtained in the disclosure with the cycloolefin monomer.

### <Preparation of Free-Standing Film for Optical Measurement>

Free-standing films for optical measurement used for measuring total transmittance (T.T) and haze value described below were prepared. Cyclopentyl methyl ether (CPME) was used as a solvent, and the polymer was added to the solvent until saturation. A clear solution obtained by filtering this saturated solution was used as a casting solution. The casting solution was applied to an aluminum cup with a diameter of 45 mm, allowed to stand and air-dried, and then peeled from the aluminum cup to obtain free-standing films for optical measurement of various polymers. The film thickness of these free-standing films was determined by measuring the film thickness at 10 points and taking the average value as the film thickness. The film thickness was measured using a digital length measuring instrument (DIGIMICRO, manufactured by Nikon Corporation).

### Example 7

A free-standing film for optical measurement was prepared using the polymer described in Example 4. The film thickness of the obtained free-standing film was 13 μm.

### Example 8

A free-standing film for optical measurement was prepared using the polymer described in Example 5. The film thickness of the obtained free-standing film was 14 μm.

### Example 9

A free-standing film for optical measurement was prepared using the polymer described in Example 6. The film thickness of the obtained free-standing film was 14 μm.

### Comparative Example 2

A free-standing film for optical measurement was prepared using the polymer described in Comparative Example 1. The film thickness of the obtained free-standing film was 15 μm.

### <Measurement of Total Transmittance (T.T)>

For the free-standing films composed of the polymers described in Example 7 to Example 9 and the free-standing film composed of the polymer using dicyclopentadiene alone, described in Comparative Example 2, the total transmittance (T.T) was measured in accordance with JIS K7361-1. NDH7000 (manufactured by Nippon Denshoku Industries Co., Ltd.) was used for the measurement.

### <Results of Total Transmittance (T.T) Measurement>

The T.T values of the free-standing films composed of the polymers described in Example 7 to Example 9 and the free-standing film composed of the polymer using dicyclopentadiene alone, described in Comparative Example 2, were as follows. Example 7: T.T=90%, Example 8: T.T=90%, Example 9: T.T=90%, and Comparative Example 2: T.T=91%.

### <Measurement of Haze Value>

For the free-standing films composed of the polymers described in Example 7 to Example 9 and the free-standing film composed of the polymer using dicyclopentadiene alone, described in Comparative Example 2, the haze value was measured in accordance with JIS K7136. NDH7000 (manufactured by Nippon Denshoku Industries Co., Ltd.) was used for the measurement.

### <Results of Haze Value Measurement>

The haze values of the free-standing films composed of the polymers described in Example 7 to Example 9 and the free-standing film composed of the polymer using dicyclopentadiene alone, described in Comparative Example 2, were as follows. Example 7: haze value=16%, Example 8: haze value=20%, Example 9: haze value=16%, and Comparative Example 2: haze value=18%.

### <Measurement Results of Free-Standing Film for Optical Measurement>

Table 3 shows the measurement results of film thickness, T.T, and haze value of the free-standing films composed of the polymers described in Example 7 to Example 9 and the free-standing film composed of the polymer using dicyclopentadiene alone, described in Comparative Example 2.

TABLE 3

| | Film Thickness (μm) | T.T (%) | Haze Value (%) |
|---|---|---|---|
| Example 7 | 13 | 90 | 16 |
| Example 8 | 14 | 90 | 20 |
| Example 9 | 14 | 90 | 16 |
| Comparative | 15 | 91 | 18 |
| Example 2 | | | |

The results of optical measurement of the free-standing films shown in Table 3 demonstrated that by copolymerizing the organopolysiloxane compound obtained in the disclosure with the cycloolefin monomer, surface properties such as improved water repellency and sliding properties can be modified without significantly impairing the optical properties of the cycloolefin polymer.

### INDUSTRIAL APPLICABILITY

The organopolysiloxane compound obtained in the disclosure shows effects of enhancing the water repellency of a cycloolefin polymer through copolymerization with a cycloolefin monomer, and therefore is expected to be utilized as an additive for enhancing the water repellency and antifouling properties of the cycloolefin polymer.

What is claimed is:

1. An organopolysiloxane compound, represented by formula (1), 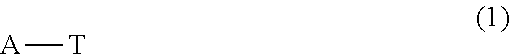
wherein in formula (1), A is a monovalent alicyclic hydrocarbon group having 4 to 60 carbon atoms and having at least one carbon-carbon double bond, and T is a group represented by formula (2), 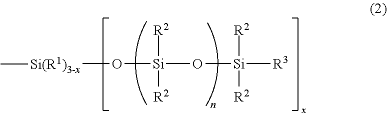
in formula (2), R¹ and R² are independently alkyl having 1 to 10 carbon atoms or aryl having 6 to 10 carbon atoms, R³ is alkyl having 4 to 10 carbon atoms, x is an integer of 1 to 3, n is an integer of 1 or more, in the case where there are a plurality of R¹ or R³ in the formula, the plurality of R¹ or R³ may be the same or different, and a plurality of R² may be the same or different.

2. The organopolysiloxane compound according to claim 1, wherein A in formula (1) is a group represented by formula (3), 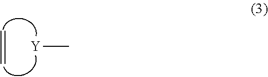
in formula (3), Y is a trivalent group comprising a hydrocarbon group having 2 to 36 carbon atoms, a substituted hydrocarbon group having 3 to 58 carbon atoms, a heteroatom-containing hydrocarbon group having 2 to 36 carbon atoms, or a substituted heteroatom-containing hydrocarbon group having 2 to 58 carbon atoms, and the trivalent group may have at least one cyclic structure, and the trivalent group may have an unsaturated bond.

3. The organopolysiloxane compound according to claim 1, wherein A in formula (1) is a group represented by formula (4a), formula (4b), formula (4c), or formula (4d), 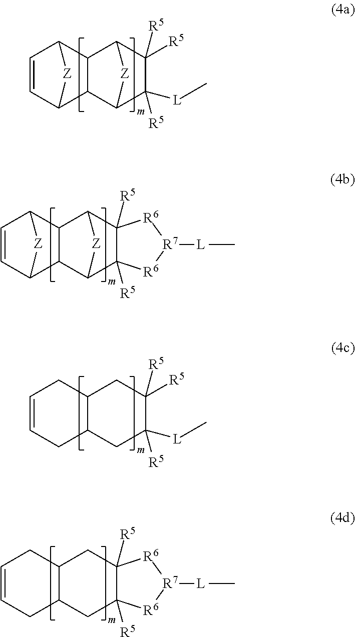
in formula (4a) to formula (4d), R⁵ is independently hydrogen or a monovalent hydrocarbon group having 1 to 4 carbon atoms, which may have an unsaturated bond, R⁶ is independently a divalent group comprising a hydrocarbon group having 1 to 4 carbon atoms, a substituted hydrocarbon group having 3 to 20 carbon atoms, a heteroatom-containing hydrocarbon group having 1 to 4 carbon atoms, or a substituted heteroatom-containing hydrocarbon group having 1 to 20 carbon atoms, and the divalent group may have an unsaturated bond, R⁷ is methine (CH) or a trivalent hetero element, L is a divalent hydrocarbon group having 2 to 10 carbon atoms, which may have an unsaturated bond, Z is methylene or 1,2-ethanediyl, and m is an integer of 0 to 3.

4. The organopolysiloxane compound according to claim 3, wherein A in formula (1) is a group represented by formula (4a), formula (4b), formula (4c), or formula (4d), R⁵ in formula (4a) or formula (4c) is hydrogen, L is 1,2-ethanediyl, m is 0, R⁵ in formula (4b) or formula (4d) is hydrogen, R⁶ is carbonyl, R⁷ is nitrogen, and L is 1,3-propanediyl.

5. The organopolysiloxane compound according to claim 4, wherein A in formula (1) is a group represented by formula (4a) or formula (4b), and x in formula (2) is 2 or 3.

6. A polymer, obtained by polymerizing the organopolysiloxane compound according to claim 1 with a cycloolefin monomer.

7. The polymer according to claim 6, obtained by polymerizing in the presence of a metathesis polymerization catalyst.

8. A free-standing film, comprising the polymer according to claim 6.

9. A molded article, comprising the polymer according to claim 6.
